(19) United States
(12) Patent Application Publication
(10) Pub. No.: US 2026/0302200 A1
(43) Pub. Date: Oct. 1, 2026

(54) TITANIUM NIOBIUM OXIDE AND MOLYBDENUM OXIDE MULTICOMPONENT ELECTRODES FOR THICK ALL ACTIVE MATERIAL LITHIUM ION ELECTRODES

(71) Applicant: UNIVERSITY OF VIRGINIA PATENT FOUNDATION, Charlottesville, VA (US)

(72) Inventors: Gary M. Koenig Jr., Fishersville, VA (US); Chen Cai, Charlottesville, VA (US)

(21) Appl. No.: 19/478,106

(22) PCT Filed: Apr. 24, 2024
(86) PCT No.: PCT/US2024/025999

§ 371 Date: Oct. 23, 2025

Related U.S. Application Data
(60) Provisional application No. 63/497,876, filed on Apr. 24, 2023.

(51) Int. Cl. H01M 4/485; C01G 33/00; H01M 4/04; H01M 10/0525

(52) U.S. Cl. CPC H01M 4/485; C01G 33/00; H01M 4/0471; H01M 10/0525; C01P 2002/72; C01P 2006/40

(57) ABSTRACT

A device may include an electrochemical storage device comprising an electrode having materials with targeted stoichiometry of TiNb2O7 (TNO), MoO2 (MO), or mixtures of TNO and MO.

### CLAIM OF PRIORITY AND CROSS-REFERENCE TO RELATED APPLICATIONS

This application claims the benefit of priority to U.S. Provisional Patent Application Ser. No. 63/497,876 entitled “TITANIUM NIOBIUM OXIDE AND MOLYBDENUM OXIDE MULTICOMPONENT ELECTRODES FOR THICK ALL ACTIVE MATERIAL LITHIUM ION ELECTRODES,” filed Apr. 24, 2023, which is incorporated herein in its entirety by reference.

### STATEMENT OF GOVERNMENT SUPPORT

This subject matter was made with Government support under Grant No. 1652488 awarded by the National Science Foundation. The U.S. Government has certain rights in this subject matter.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various aspects of the present subject matter.

FIG. 1 is a schematic diagram showing fabrication of different all active material (AAM) anodes.

FIG. 2 shows X-ray diffraction patterns for 0% MO, 25% MO, 50% MO, 75% MO, and 100% MO, with relevant reference patterns.

FIG. 3 is a graph showing Vickers hardness and geometric pore/void volume fraction for the AAM anodes.

FIG. 4A and FIG. 4B comprise a series of graphs showing at FIG. 4A voltage profiles and at FIG. 4B dQ/dV for the first charge and discharge cycle at C/40 (0.87 mA cm⁻²), for AAM LCO cathodes paired with AAM anode.

FIG. 5A and FIG. 5B comprise a series of graphs showing at FIG. 5A discharge capacity at C/40, C/20, C/10, and C/5 for the indicated AAM anode paired with LCO AAM cathodes. FIG. 5B show Ragone plot for cells with AAM electrodes in this work and prior reports, where all had areal capacity over 10 mAh cm⁻².

FIG. 6A, FIG. 6B, FIG. 6C, FIG. 6D, and FIG. 6E comprise a series of graphs showing voltage profiles for cells with AAM LCO cathodes paired with AAM anodes at FIG. 6A of 0% MO, at FIG. 6B of 25% MO, at FIG. 6C of 50% MO, at FIG. 6D of 75% MO, and at FIG. 6E of 100% MO at the 1^{st}, 5^{th}, 30^{th}, 50^{th} and 70^{th} cycle, where the cycles were at a rate of C/40 (0.87 mA cm⁻²) using a voltage window of 1.0-3.2 V (cell).

FIG. 7A, FIG. 7B, FIG. 7C, and FIG. 7D comprise a series of graphs showing calculations from P2D simulations of the solid phase lithium concentration within the AAM anode region at FIG. 7A for 0% MO, at FIG. 7B for 100% MO, at FIG. 7C for TNO component in 75% MO, and at FIG. 7D for MO component in 75% MO cell. All anodes were paired with LCO AAM cathodes.

FIG. 8A and FIG. 8B comprise a series of graphs showing simulated lithiation contributions from TNO and MO from the anode in the 75% MO cell on a molar basis during the first charge cycle.

FIG. 9 is a graph showing XRD of the TNO materials synthesized at temperatures of 1000° C., 800° C., 700° C., and 600° C.

FIG. 10A and FIG. 10B comprise a series of graphs showing at FIG. 10A, first charge/discharge voltage profiles at C/10 and at FIG. 10B the corresponding calculated dQ/dV from those profiles for composite cells paired with Li foil anodes. The electroactive materials in the composite cathodes were the TNO powders synthesized at 1000° C., 800° C., 700° C., and 600° C.

FIG. 11A and FIG. 11B comprise a series of graphs showing at FIG. 11A first charge/discharge voltage profiles at C/50 (0.85 mA cm⁻²) and at FIG. 11B corresponding calculated dQ/dV profiles for AAM LCO cathodes paired with TNO AAM anodes which had been processed at 1000° C., 800° C., 700° C., and 600° C.

FIG. 12A, FIG. 12B, FIG. 12C, and FIG. 12D comprise a series of graphs showing discharge voltage profiles at FIG. 12A for 1000 C, FIG. 12B for 800 C, FIG. 12C for 700 C, and FIG. 12D for 600 C TNO AAM anode materials for the 1^{st}, 2^{nd}, 3^{rd}, 4^{th}, 5^{th}, and 25^{th} cycle. All cells had an identically processed LCO AAM cathode and used the same current for charge and discharge (corresponding to C/50, 0.85 mA cm⁻²). Cells were cycled between 1.0-3.1 V.

FIG. 13A, FIG. 13B, FIG. 13C, and FIG. 13D comprise a series of graphs showing charge/discharge voltage profiles at higher rates at FIG. 13A of C/20, at FIG. 13B of C/10, and at FIG. 13C of C/5, taken from (d) the rate capability evaluations of FIG. 13D of the AAM TNO anodes processed using the 1000 C, 800 C, 700 C, and 600 C materials. The same rate was used for both charge and discharge cycles. C/5 corresponded to a current density of 8.5 mA cm². The cathode for all cells was identically processed AAM LCO. 1000 C sample data not shown due to severe fade in previous cycles. Cells were cycled between 1.0-3.1 V (cell).

FIG. 14 is a graph showing high frequency intercepts (R_{cell}) extracted from electrochemical impedance spectroscopy (EIS) measurements for the 1000 C, 800 C, 700 C, and 600 C AAM materials paired with Li metal. EIS was conducted on the freshly prepared cells and after discharge and hold at the voltages (relative to Li/Li⁺) indicated on the x-axis.

FIG. 15A and FIG. 15B comprise a series of graphs showing voltage and capacity of cells.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the subject matter, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

Lithium-ion batteries (LIB) for decades have shaped human society. Further improving LIBs and increasing energy density continues to be a focus of researchers. A general approach for higher energy density is to increase electrode areal loading, resulting in reduction of inactive components such as current collectors at the cell level. However, conventional composite electrodes fabricated using slurry casting have inherent mechanical limitations at thickness over ~100 μm. In addition, the calendaring process and presence of inactive polymer binders and conductive additives collectively increase the tortuosity within interstitial regions of the solid conventional composite electrodes, further limiting cell power and rate capability.

In addition to the aforementioned benefits, the electrochemical storage devices described herein exhibit superior performance characteristics when utilized in high-demand applications. For instance, the high rate capability and stable cycling of the electrodes make them particularly suitable for use in electric vehicles, where rapid charging and discharging are often required. Furthermore, the unique composition of the electrodes, which includes a mixture of TNO and MO, provides a balanced approach to achieving high energy density without compromising on power delivery or cycle life. This balance is critical in applications such as portable electronics and power tools, where both long-term reliability and immediate power output are essential.

To mitigate these constraints while still achieving thick electrodes with high loading, all-active-material (AAM, referred to in some prior work as “sintered electrodes”) electrodes without conductive additives and polymer binders have been reported, with extremely high loadings over 100 mg cm⁻² and thicknesses over 1 mm in some cases. AAM electrodes were typically fabricated via hydraulic compression and mild sintering of the electroactive material powder. Such processing improves mechanical strength of the pellets while still maintaining pores/voids in the pellet at volume fractions of 0.3-0.4. This relatively high porosity compared to conventional solid densification/sintering aids in facilitating ion transport through the electrode matrix after filling the pores with electrolyte. As an example of the relative ion transport advantages of the inactive material free electrodes, the Bruggeman exponent for AAM electrodes were reported much lower (between 1-1.5) than those of conventional composite electrodes (in some cases exceeding 4).

In the absence of conductive additives such as carbon black, electronic conduction through the electrode matrix must occur via the electroactive material itself in AAM electrodes. Li₄Ti₅O₁₂ (LTO) anodes and LiCoO₂ (LCO) cathodes have often been used in AAM electrodes in part because of their high electronic conductivity, >10 S m⁻¹ across the range of lithiation expected during charge/discharge. Additional evidence to support the important role of electroactive material electronic conductivity was a report using LiMn₂O₄ (LMO) as an AAM cathode, where limited rate capability was attributed to low material electronic conductivity, and dopants which increased electronic conductivity also slightly mitigated the cycling limitations. Besides material doping, another approach to address limited electronic conductivity of a desired electroactive material was recently reported. A multicomponent blend AAM electrode was fabricated with a high energy, low electronic conductivity material combined with a lower energy, high electronic conductivity material. For that specific study, high electronic conductivity LCO particles and relatively low electronic conductivity LiNi_{0.5}Mn_{0.5}O₂(LNMO) particles were physically blended and fabricated into AAM electrodes. LCO and LNMO were both layered phase oxides, and the resulting phases remained segregated. Above a content threshold, the percolated LCO network increased the matrix electronic conductivity, which then no longer was the limiting factor during cycling. Multicomponent blend electrodes resulted in much better electrochemical outcomes relative to either individual material in isolation. In addition, the blended AAM electrodes rendered the best cycling stability, which was speculated to result from improved mechanical properties.

As mentioned herein, LTO has often been used as the anode in AAM cells in part due to low volume change with cycling and high electronic conductivity. However, LTO has relatively low volumetric capacity compared to other electroactive material options. An alternative anode material with much higher energy density, titanium niobium oxide (TNO, including different blends of Ti and Nb oxides with overall stoichiometric target of TiNb₂O₇) was recently evaluated in AAM anodes. TNO retained high energy density, but with relatively low electronic conductivity cycling at increasing rates was challenging. In addition, stability with extended cycling with TNO was also inferior to LTO, which was speculated to result from higher volume change and lower interface stability for the TNO materials relative to LTO. Another intercalation-type alternative anode material, MoO₂ (MO), has been reported to have much greater electronic conductivity of 190 S cm⁻¹. This material has been reported, however, to have the challenge of relatively large volume change during lithiation/delithiation of up to ~14%. Herein, this study will describe evaluating the multicomponent AAM concept on an anode material for the first time, where relatively high energy density TNO will be blended with relatively high electronic conductivity MO. Drastic improvements in cycling stability and rate capability were achieved for blends of TNO and MO in AAM electrodes compared to individual AAM electrodes with either TNO or MO alone.

According to an aspect of this disclosure, TNO was synthesized via sol-gel method. As further disclosed, TNO can be processed into both composite and sintered electrodes and evaluated electrochemically when paired in half and full cell configurations. The outcomes disclosed herein show that TNO is a suitable material as a sintered anode, providing stable and reversible electrochemical cycling.

The methods of fabricating the electrodes, as detailed in the Examples, highlight the versatility of the manufacturing process. The ability to adjust the sintering temperature and duration allows for the fine-tuning of the electrode's microstructure and, consequently, its electrochemical properties. This adaptability is crucial for customizing the electrodes to meet specific requirements of various applications. For example, lower temperature processing may yield electrodes with higher capacity retention, which is advantageous for stationary energy storage systems where long-term stability takes precedence over high power output.

More specifically, the instant disclosure shows that the energy density of lithium-ion batteries at a cell level can be improved via increasing thickness and reducing inactive material content of electrodes. One system which achieves both attributes are sintered electrodes comprised of porous thin films of only electroactive material. Li₄Ti₅O₁₂ has often been the used as a sintered anode, however, higher energy density anodes could significantly improve cell energy density. As disclosed herein, TiNb₂O₇ (TNO) was synthesized and evaluated as a sintered anode material. Sintered TNO had stable cycling and relatively high volumetric energy density, suggesting TNO has promise as a sintered anode.

Sintered electrodes have been reported which are free of inactive conductive additives and binders, with high loadings exceeding 150 mg cm⁻² and thicknesses over 500 μm. The electrode microstructure for sintered electrodes does not contain inactive additives in the interstitial regions between particles, and thus sintered electrodes have lower tortuosity than conventional composite electrodes. However, the electrodes are still very thick, and thus ion transport limitations through the microstructure and electron transport through the electrode matrix can result in high polarization and rate capability limitations. Because electron conduction through the electrode matrix must proceed through the electroactive material itself in sintered electrodes, materials with relatively high electronic conductivity across the range of extents of lithiation experienced during charge/discharge of the cell are desirable.

As disclosed herein, the concept of combining multiple electrode materials is explored in a sintered electrode system. Composite electrodes experience relatively low temperatures during processing, and the individual active material particles (at least before calendaring) are generally separated from one another. In contrast, sintered electrode electroactive material particles have many contact points due to compression during processing, and then are subjected to temperatures which are mild for sintering but much higher than composite electrode solvent removal temperatures. Ideally, the benefits previously observed for multicomponent composite electrodes would translate directly to sintered electrodes; however, the dissimilar materials processed in direct contact with one another may result in unique considerations as will be discussed herein.

According to various examples of the instant disclosure, sintered cathodes containing both TNO and MO, will be described. For example, one can be a homogeneous blend, where powders of the two materials are blended together and then processed into a sintered electrode, which will be referred to as “Blend”. For the other two cases, the same relative fraction of materials as the homogeneous blend were used, however the powders can be segregated into two separate layers. Then, the two-layer sintered electrode can be fabricated into a cell where either the MO component was on the current collector side (or the MO component can be on the current collector side. Previous reports with sintered electrodes have suggested that the progression of lithiation/delithiation within the electrode as a function of electrode depth are dependent on the relevant electronic and ionic transport restrictions in the system. Thus, the drastically different electronic conductivity of TNO and MO provided a system to assess how the location of the electronically conductive material layer influenced electrochemical outcomes for the cell. The results for these three systems will be discussed in the context of electrochemical characterization and pseudo-two-dimensional (P2D) simulations of the electrochemical cells.

The electrochemical storage devices described herein are also designed with sustainability in mind. The use of materials such as TNO and MO, which can be derived from abundant resources, ensures a lower environmental impact compared to electrodes made from scarcer materials. Additionally, the absence of binders and conductive additives in the sintered electrodes not only simplifies the manufacturing process but also reduces the potential for environmental contamination during both production and disposal. These considerations are increasingly important as the global demand for energy storage solutions continues to grow.

In view of the foregoing, in accordance with various aspects, an electrochemical storage device can include an electrode. The electrode can include many suitable materials. Examples of suitable materials can include a mixture of TNO and MO. Depending on various aspects, the electrode can be an anode or a cathode. In specific examples, a cathode can include TNO or MO. In some examples, the cathode or anode can include at least one dopant, at least two dopants, or any suitable number. The at least one dopant has a 1⁺, 2⁺, or 3⁺ oxidation state. As non-limiting examples, the at least one dopant comprises copper, aluminum, sulfur, potassium, or a mixture thereof.

The benefits of the electrodes described herein can be achieved when the electrode is a sintered electrode or a composite electrode. In examples where the electrode is a composite. While not so limited, a substrate can include a stainless steel, aluminum, alloys thereof, or mixtures thereof.

As explained herein, electrode thickness is an important parameter of the electrode. As an example, a thickness of the electrode can be in a range of from about 50 μm to about 2000 μm, about 70 μm to about 400 μm, less than, equal to, or greater than about 50 μm, 60, 70, 80, 90, 100, 110, 120,130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, 1650, 1660, 1670, 1680, 1690, 1700, 1710, 1720, 1730, 1740, 1750, 1760, 1770, 1780, 1790, 1800, 1810, 1820, 1830, 1840, 1850, 1860, 1870, 1880, 1890, 1900, 1910, 1920, 1930, 1940, 1950, 1960, 1970, 1980, 1990, or about 2000 μm.

A porosity of the electrode can be in a range of from about 30% to about 50%, about 35% to about 40%, less than, equal to, or greater than about 30%, 31, 32, 33, 34, 35, 36, 37, 38, 39, 40, 41, 42, 43, 44, 45, 46, 47, 48, 49, or about 50%. The porosity can alternatively be expressed as a void space of the portion of the electrode that is empty. The pores can be through pores in some examples.

According to various examples, the electrode is substantially free of any conductive additives. For example, the electrode can include about 0 wt % to about 5 wt % conductive additive, about 0 wt % to about 0.50 wt %, less than, equal to, or greater than about 0 wt %, 0.1, 0.2, 0.3, 0.4, 0.0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or about 5 wt %. Non limiting examples of conductive additives that the electrode is free of include a polymer binder, a conductive carbon, or a mixture thereof.

The material(s) and construction of the electrode can control the capacity of the electrode. As an example, the capacity of the electrode can be in a range of from about 7 mAh/cm² to about 200 mAh/cm², about 10 mAh/cm² to about 50 mAh/cm², less than, equal to, or greater than about 7 mAh/cm², 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199 or about 200 mAh/cm².

The electrode, in some aspects, can be associated with an electrically conductive current collector to facilitate the flow of electrons between the electrode and an exterior circuit. The current collector can include metal, such as a metal foil or a metal grid. In some aspects, the current collector can be formed from nickel, aluminum, stainless steel, copper or the like. The electrode material can be cast as a thin film onto the current collector. The electrode material with the current collector can then be dried, for example in an oven, to remove solvent from the sintered electrode. In some aspects, the dried sintered electrode material in contact with the current collector foil or other structure can be subjected to a pressure, such as, from about 2 to about 10 kg/cm² (kilograms per square centimeter).

The separator is located between the positive electrode and the negative electrode. The separator is electrically insulating while providing for at least selected ion conduction between the two electrodes. A variety of materials can be used as separators. Commercial separator materials are generally formed from polymers, such as polyethylene and/or polypropylene that are porous sheets that provide for ionic conduction. Commercial polymer separators include, for example, the Celgard® line of separator material from Hoechst Celanese, Charlotte, N.C. Also, ceramic-polymer composite materials have been developed for separator applications. These composite separators can be stable at higher temperatures, and the composite materials can significantly reduce the fire risk. In some further examples the separator can include glass fibers. Glass fiber separators can be especially useful when a sintered electrode is used.

The electrolyte includes solvated ions as electrolytes, and ionic compositions that dissolve to form solvated ions in appropriate liquids are referred to as electrolyte salts. Electrolytes for lithium ion batteries can comprise one or more selected lithium salts. Appropriate lithium salts generally have inert anions. Suitable lithium salts include, for example, lithium hexafluorophosphate, lithium hexafluoroarsenate, lithium bis(trifluoromethyl sulfonyl imide), lithium trifluoromethane sulfonate, lithium tris(trifluoromethyl sulfonyl) methide, lithium tetrafluoroborate, lithium perchlorate, lithium tetrachloroaluminate, lithium chloride, lithium difluoro oxalato borate, and combinations thereof. Traditionally, the electrolyte comprises a 1 M concentration of the lithium salts, although greater or lesser concentrations can be used.

A non-aqueous liquid can be used to dissolve the lithium salt(s). The solvent generally does not dissolve the electroactive materials. Appropriate solvents include, for example, propylene carbonate, dimethyl carbonate, diethyl carbonate, 2-methyl tetrahydrofuran, dioxolane, tetrahydrofuran, methyl ethyl carbonate, γ-butyrolactone, dimethyl sulfoxide, acetonitrile, formamide, dimethyl formamide, triglyme (tri(ethylene glycol) dimethyl ether), diglyme (diethylene glycol dimethyl ether), DME (glyme or 1,2-dimethyloxyethane or ethylene glycol dimethyl ether), nitromethane and mixtures thereof.

The electrodes described herein can be incorporated into various commercial battery designs, such as prismatic shaped batteries, wound cylindrical batteries, coin batteries or other reasonable battery shapes. The batteries can comprise a single sintered electrode stack or a plurality of sintered electrodes of each charge assembled in parallel and/or series electrical connection(s). Appropriate electrically conductive tabs can be welded or the like to the current collectors, and the resulting jellyroll or stack structure can be placed into a metal canister or polymer package, with the negative tab and positive tab welded to appropriate external contacts. Electrolyte is added to the canister, and the canister is sealed to complete the battery. Some presently used rechargeable commercial batteries include, for example, the cylindrical 18650 batteries (18 mm in diameter and 65 mm long) and 26700 batteries (26 mm in diameter and 70 mm long), although other battery sizes can be used.

The sintered electrode can be formed according to many suitable methods. For example, the electroactive material of the electrode is sintered. Sintering can be performed at a temperature in range of from about 500° C. to about 1100° C., about 700° C. to about 900° C., less than, equal to, or greater than about 500° C., 550, 600, 650, 700, 750, 800, 850, 900, 950, 1000, 1050, or about 1100° C. Sintering can be conducted at a constant temperature or at a variable temperature during the sintering process. Sintering can last for any amount of time in a range of from about 0 hours to about 20 hours, about 12 hours to about 18 hours, less than, equal to, or greater than about 0 hours, 1, 2, 3, 4, 5, 6, 7, 8, 9, 10, 11, 12, 13, 14, 15, 16, 17, 18, 19, or about 20 hours. Sintering can be conducted in one step or across multiple sintering steps.

Alternatively, a composite electrode can be formed by disposing the electroactive material on a substrate. The electroactive material can be in the form of a slurry mixed with a solvent, carbon source, and any other suitable component. The substrate can be an aluminum foil. After the slurry is disposed on the substrate, the slurry is allowed to dry in an oven to form the electrode.

As mentioned previously, in some aspects the electrode can include a degree of porosity. The structure and/or arrangement of pores in the sintered electrode microstructure can lead to additional improvements in the energy and power density of the energy storage device to which the electrode is incorporated. As an example, aligning the pores can improve these properties. One method that can be used to accomplish this is to fabricate an electrode using reactants that are capable of forming an anisotropic structure. This can be accomplished by producing an anisotropic precipitate particle that includes a single transition metal or multiple transition metals. The precipitate can be used as a precursor template in formulating battery active material having an anisotropic morphology. Any suitable transition metal can be used to form the precursor template.

In producing the sintered electrode, there are different strategies to improve or overcome inherent electronic conductivity limitations of electroactive materials. One route is to dope the electroactive material with elements that result in increased electronic conductivity. There are limits to the electronic conductivity improvements via doping methods and at too high of a doping level secondary phases can result. Another option is to carbon coat the electroactive material, and this strategy has been attributed to improving rate capability of other low electronic conductivity electroactive materials such as LiFePO₄. Carbon coating of electroactive materials has been broadly reported for improved interfacial stability and electronic conductivity. Sucrose is a common carbon source that also can serve as a particulate binder material. As described herein a carbon coated sintered electrode can be produced using sucrose both as a sacrificial binder for sintered electrode processing and as a carbon source, where the carbon coating process does not require an extra step for treating the electroactive material powder or the sintered porous pellet relative to processing the electrodes without the coating.

The electrochemical storage device described herein can be disposed in many suitable articles. For example, the electrochemical storage device can be disposed in vehicle (e.g., an electric vehicle) or an electronic device.

### EXAMPLES

Various aspects of the present subject matter can be better understood by reference to the following Examples which are offered by way of illustration. The present subject matter is not limited to the Examples given herein.

### Example 1

### Materials and Methods

### Electroactive Material Fabrication

For TNO synthesis, 0.5 M of NbCl₅ was prepared in 40 mL of ethanol while stirring at 300 RPM. Upon full dissolution, 0.25 M of Ti(OC₃H₇)₄ (Sigma-Aldrich) was added to the solution. The solution was stirred for an additional 30 s before being transferred into a drying dish, and then dried in air at room temperature overnight. The dried material had the consistency of a gel, which was then dissolved into 40 mL of deionized (DI) water, and subsequently dried again in a drying dish at 80° C. overnight in air. The resulting precursor was a soft powder which was ground for 5 mins by hand using mortar and pestle, followed by heating at 700° C. for 2 h in air. The heating and cooling rates were 1° C. min⁻¹. MoO₂ was used as received from Fisher.

For LCO synthesis, 0.2 M CoSO₄·7H₂O (Acros Organics) and 0.2 M Na₂C₂O₄ (Fisher) were dissolved into 400 mL DI water each in 2 separate beakers. Both solutions were heated to 60° C. while stirring at 300 RPM, followed by pouring the cobalt solution all at once into the oxalate solution. The precipitation reaction proceeded for 30 min at 60° C. while stirring at 300 RPM. The resulting pink precipitate was collected via vacuum filtration and rinsed with 1.6 L of DI water, followed by drying at 80° C. overnight in air. The dried powder was mixed with Li₂CO₃ (Fisher) by hand using a mortar and a pestle for 10 min with a target stoichiometry of 1.05:1 Li:Co (Li excess of 5%). The mixture was heated to 800° C. with a ramping rate of 1° C. min⁻¹, and there was no hold at the target temperature. The material was then allowed to cool down to room temperature without control over the cooling rate. Preparation and characterization of LCO material via the synthesis and processing methods described in this report have been detailed in prior works.

### AAM Electrode Fabrication

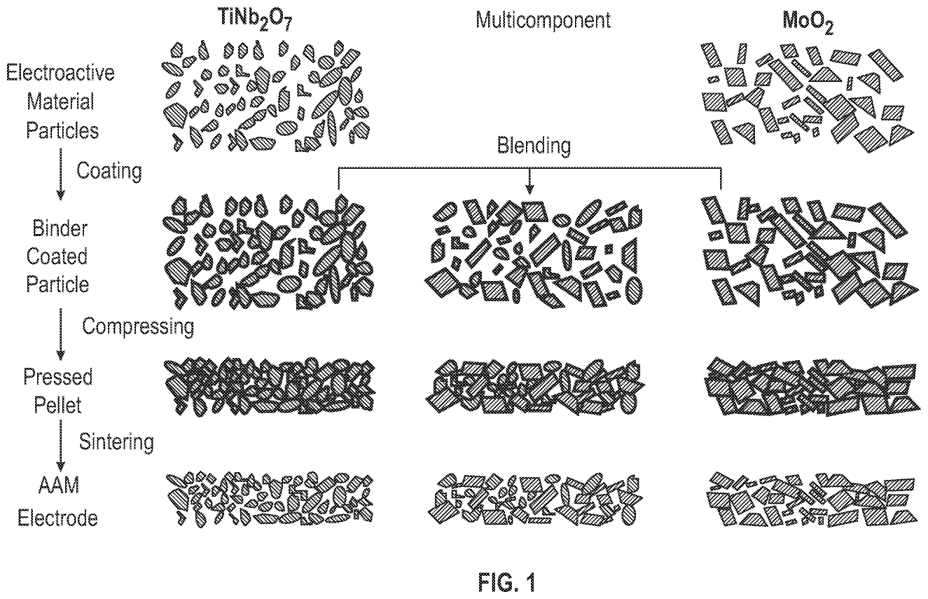

AAM anode fabrication is schematically shown in FIG. 1. First, MO powder or as-synthesized TNO powder of 1.0 g was blended with polyvinyl butyral (PVB, Pfaltz & Bauer) solution (1 wt % in ethanol) into a slurry using a mortar and pestle by hand. The slurry continued to be stirred until dried. Five AAM anodes consisting of 100:0 MO:TNO, 75:25 MO:TNO, 50:50 MO:TNO, 25:75 MO:TNO, and 0:100 MO:TNO by mass (noted as 100% MO, 75% MO, 50% MO, 25% MO, and 0% MO) were fabricated. For the 100% MO or 0% MO, the PVB-coated MO or TNO was loaded into a circular die with diameter of 1.3 cm⁻² and pressed at 400 MPa for 2 mins. For the 75% MO, 50% MO, and 25% MO, the PVB-coated powder was blended using a mortar and pestle for five minutes. All powder mixtures were pressed using the same procedure. The pressed pellets were then heated in argon at 600° C. for 1 h with heating and cooling rates of 2° C. min⁻¹. To ensure a fair comparison of the full cell electrochemical properties, given the inherent capacity differences of the electrodes, the loading of each cell was targeted to achieve similar first charge cell capacity (30-32 mAh cm⁻²). The detailed electrode dimensions of each cell after heat treatment are listed in Table 1. All AAM anodes paired with LCO cathodes were anode limited in capacity. For electrochemical impedance spectroscopy (EIS) measurements, AAM electrode loading was decreased to 7.7-8.5 mAh cm⁻² because the other electrode was lithium metal and the lower loading alleviated the total amount of lithium metal which needed to be stripped.

TABLE 1
Dimensions for AAM electrodes evaluated.

| | 0% | 25% | 50% | 75% | 100% |
|---|---|---|---|---|---|
| Sample | MO | MO | MO | MO | MO |
| Thickness (μm) | 490 | 450 | 430 | 420 | 420 |
| Porosity (%) | 45% | 42% | 42% | 42% | 45% |
| Loading (mg cm⁻²) | 119 | 125 | 132 | 144 | 152 |

In AAM full cells, the cathode was LCO in all cases. The same PVB coating procedure was followed for AAM LCO, and the pressed pellets were sintered in air at 600° C. for 1 hour, where both heating and cooling rates were 1° C. min⁻¹. The as-prepared pellets had thicknesses of 740-780 μm, areal loadings of 260-264 mg cm⁻², and geometric pore/void fractions of ~0.32. With all cells being anode limited, the initial charge capacity for all cells on a cathode mass basis was always less than 120 mAh g⁻¹ LCO, and at increasing rates the overall LCO electrode gravimetric capacity was even less. Low capacity and extent of delithiation of LCO was desired to reduce the likelihood of any capacity loss during cycling being caused by structural instability resulting from excessive delithiation.

### Material Characterizations and Electrochemical Evaluations

X-ray diffraction (XRD) profiles were collected using a PANalytical X′pert ProMPD diffractometer with Cu Kα source. Scanning electron microscopy (SEM) imaging and energy dispersive X-ray spectroscopy (EDS) analysis were performed using a FEI Quantum 650 microscope. Vickers hardness was measured using a Tinius Olsen model FH 14-1 hardness testing instrument with compressive loading of 50 g force and dwell time of 10 s. The Vickers hardness value was calculated in Pascal through the applied force and indentation size. Triplicates (different regions on the same pellet) were conducted for Vickers analysis for each sample.

For AAM electrodes evaluated in full cells, the AAM electrode (anode or cathode) was attached to a stainless steel current collector (anode onto a spacer and cathode onto a bottom piece for a 2032-type coin cell) using a customized paste. The paste was made by mixing acetylene carbon black (CB), polyvinylpyrrolidone (PVP, Sigma Aldrich, 360 kDa molecular weight), and ethanol with a weight ratio of 1:1:20 CB:PVP:ethanol using a slurry mixer (Thinky). The attached AAM electrode was then dried at 80° C. for 30 mins under vacuum, before being transferred into an argon glove box. Separators (glass fiber, G6 from Fisher) were punched out as circles with areas of 2 cm², and the electrolyte was 1.2 M LiPF₆ in 3:7 ethylene carbonate:ethyl methyl carbonate (Gotion). Full cells were cycled between 1.0-3.2 V (cell) on a Maccor battery cycler. The initial cycle was at a rate of C/40, which was determined by assuming 120 mAh g⁻¹ LCO as the basis for the C rate. This rate corresponded to a current density of 0.87 mA cm⁻².

For AAM electrode EIS measurements, each of the five AAM TNO and/or MO electrodes were paired with circular Li foil anodes punched to have areas of 1.6 cm². The separator was two layers of Celgard 2325 punched into circles with areas of 2 cm², and the electrolyte was the same used in AAM full cells. EIS measurements were conducted using a Gamry Reference 600 on freshly made cells and after five cycles between 1.0-3.0 V at 0.85 mA cm⁻² (~C/10). EIS parameters were extracted after fitting the experimental data to an equivalent circuit using Zview.

### Pseudo-Two-Dimensional (P2D) Simulation

Simulations were based on the pseudo-two dimensional (P2D) framework originally developed by the field, with the model modified to reflect the changes in the cell due to the change from conventional composite electrodes to AAM electrodes. In brief, because AAM electrodes do not contain conductive additives, electron conduction through the electrode matrix must occur through the solid AAM electroactive material itself. For different extents of lithiation of the material, the inherent electronic conductivity would be expected to vary by several orders of magnitude based on the reported relationship between state of charge and electronic conductivity for relevant LIB materials. Such electronic conductivity relationships can drastically impact the simulated voltage during charge/discharge and lithiation reaction distribution across the electrode depth. The electronic conductivity for TNO as a function of extent of lithiation was based on existing literature, where before lithiation it was as low as 10⁻⁹ S cm⁻¹. However, with ~20 mAh g⁻¹ Li inserted, the conductivity increased to above 10⁻² S cm⁻¹ and remained at around 10⁻³ S cm⁻¹ with further lithiation. For MO, a fixed electronic conductivity as a function of extent of lithiation was used due to a lack of available reported literature values. Instead, it was assumed that MO had a fixed electronic conductivity of 190 S cm⁻¹, which has been reported for this material without any lithiation. One study has reported that upon lithiation the electronic conductivity of MO could further increase, thus the value used likely reflected the lower limit. It is noted that a solid electrode matrix electronic conductivity over 10⁻² S cm⁻¹ would not be expected to limit cell performance. Therefore, unless the MO undergoes multiple orders of magnitude decrease in electronic conductivity with lithiation, it would not be expected to influence the simulation outcomes much.

Simulations were performed using implicit numerical methods in Python 3.7. The system of partial differential equations (PDE) can be found in the field and also in the Supporting Information. The detailed parameters can also be found in Supporting Information, Tables S1-S3. In this work, only the first charge cycle was simulated to remove the complications of accounting for capacity losses and cycle fading. Volume change in the electrode materials as a function of electrode depth was a new feature added to the simulations. To implement the volume change in the calculations, the lattice volume changes were assumed to vary linearly with the extent of lithiation, while the volume increases assumed at maximum lithiation were 14% for MO (~0.98 mole Li per MO or 205 mAh g⁻¹ MO) and 10% for TNO (~3.5 mole Li per TNO or 289 mAh g⁻¹ TNO). The material lattice volume change was approximated based on the extent of lithiation; however, the dimensions of the nodes in the simulation remained constant. The electrode dimensions used for cathode were identical in the simulation, and the dimensions used for the anode can be found in Table 1.

### Results and Discussions

### Materials Characterizations

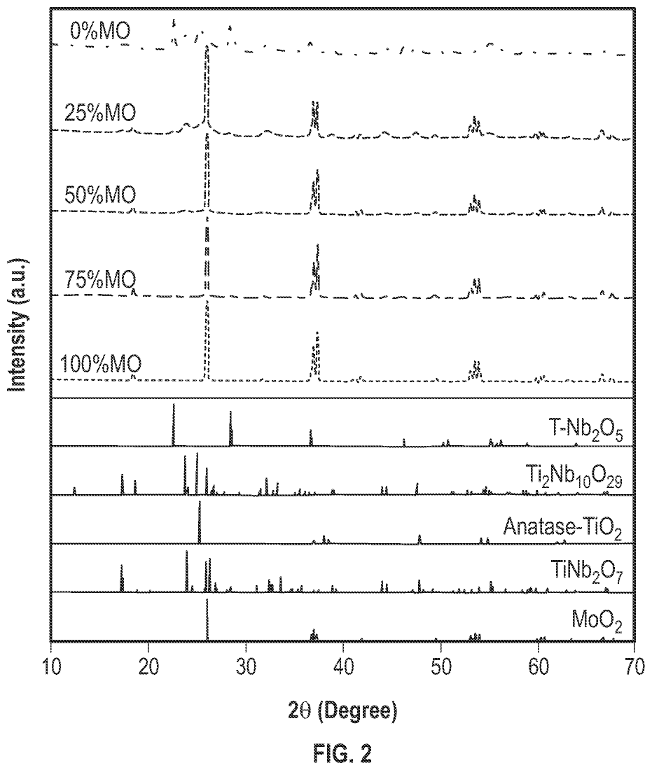

XRD profiles for the AAM anodes can be found in FIG. 2. For the 0% MO (pure TNO), the result was consistent with a recent study. The sample had multiple phases and likely contained TiNb₂O₇, T-Nb₂O₅, and some trace amounts of other TiₓNb_{y}O_{z} phases and anatase TiO₂. This multiphase TNO material was synthesized at 700° C., which was identified as the optimum temperature resulting in the best cycle stability in a prior work with TNO AAM electrodes. For the 100% MO, no impurity peaks were observed. It was a monoclinic phase with space group of P21/c, consistent with previous reports. It was noted that the 2θ peak at 18.4° had a much higher intensity than the reference pattern, although the origin of this difference in relative peak intensities was not further investigated. For the 25% MO, 50% MO, and 75% MO, diffraction peaks correspond to the phases in either TNO or MO, and no new peaks were observed. This observation suggested that MO and TNO did not react to form new phases after the mild sintering process.

SEM images of as-received MO powder and as-synthesized TNO powder were studied. The MO powder exhibited flake shape with primary particle size of ~200 nm. The TNO powder had more irregular morphology with primary particle size below 100 nm, consistent with a previous report for this material using similar synthesis routes. After pressing and sintering, the 0% MO (pure TNO) particles did not undergo obvious morphology change. The 100% MO retained a flake morphology after compression and heating, but the packing of the flakes was denser (though still porous). For the 25% MO, 50% MO, and 75% MO, particle morphologies consistent with the original TNO and MO were observed in the pressed and heated pellet. This result indicates that no particle coarsening or reactions between TNO and MO occurred during the heat treatment.

Although the XRD result revealed multiple Ti and Nb phases present in the TNO, EDS maps suggested the Ti and Nb were both distributed homogenously. TNO and MO apparently remained separated with no evidence of interdiffusion or reaction, which was consistent with the XRD result. It is noted that in the absence of the heat treatment step, the porous pellets had almost no structural integrity and could not survive further processing to electrodes. This suggested that while new phases and particle coarsening were not observed, interparticle connections took place during the thermal treatment which strengthened samples.

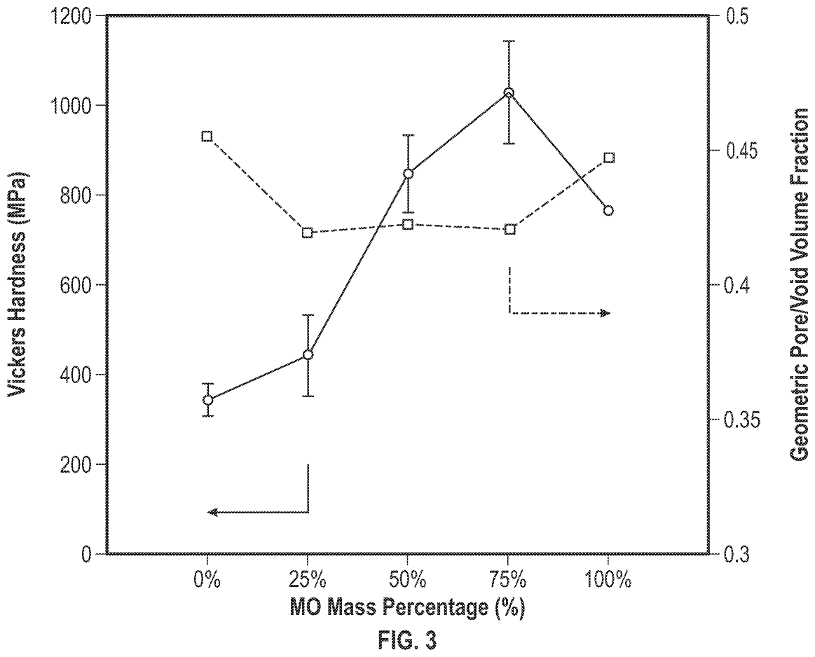

FIG. 3 displays the Vickers hardness and geometric pore/void volume fraction for each AAM TNO/MO electrode evaluated. The indentation dimension in the hardness test was much larger than the sizes of MO and TNO particles. Thus, the measured hardness values reflect the global mechanical performance of all samples. For 0% MO and 100% MO, the pore/void volume fraction was ~0.45, which was slightly higher than previously reported ranges for AAM electrodes of other materials via similar processing of 0.32-0.41. This outcome could originate from the different particle morphology, the surface energy, or diffusivity of the constituent materials. The 25% MO, 50% MO, and 75% MO all had lower pore/void volume fractions of ~0.42, suggesting the higher packing density was achieved for mixing the MO flakes and TNO aggregates with different sizes and shapes. Parenthetically, full-density pellet samples were not expected given the heating process at such low processing temperature. The Vickers hardness of MO and TNO relevant phases in dense solid form have been previously reported, including values of 8.6 GPa for MoO₂, 6.9 GPa for anatase, 8.1 GPa for TiNb₂O₇, and 3.9 GPa for Nb₂O₅. The Vickers hardness of the 0% MO and 100% MO samples were 340 MPa and 770 MPa, respectively, which was reasonable because of their porosity, given the hardness of brittle materials exponentially decreases as porosity increases. For the MO-TNO samples, the hardness increased dramatically with the fraction of MO. The 75% MO sample achieved the highest hardness value, even harder than the 100% MO sample. This was because the hardness of a sample is affected by both the fraction of the harder MO particles and the porosity of the sample. The differences in size and morphology of MO and TNO particles were beneficial in increasing the initial packing density of the raw powder and also in enhancing the particle-particle connections, which resulted in the highest hardness with 75% MO instead of 100% MO. Higher packing density not only reduces the pore/void volume fraction of the samples but also promotes the growth of any particle-particle connections during the sintering process.

### Electrochemical Evaluations and P2D Simulations

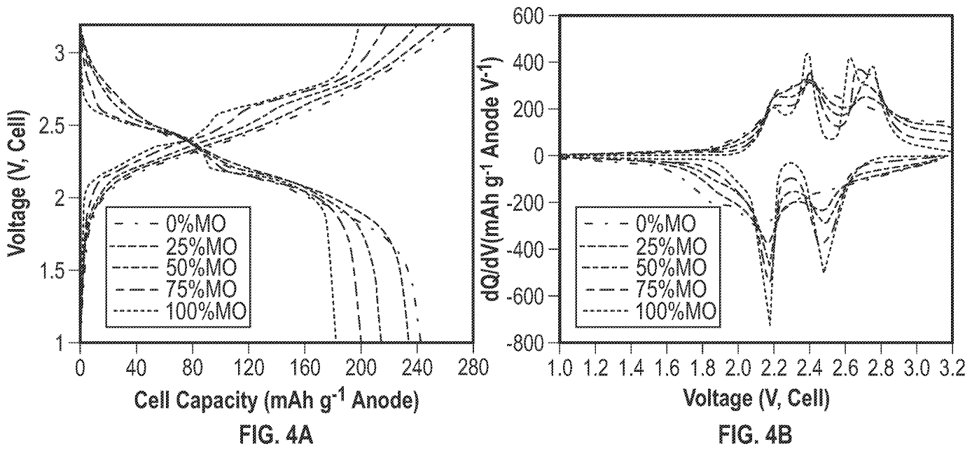

The first charge and discharge voltage profiles and corresponding dQ/dV for cells with AAM LCO cathodes paired with the different compositions of AAM TNO/MO anodes can be found in FIG. 4. Selected electrochemical information for the cells is summarized in Table 2. The 0% MO (pure TNO) first charge and discharge at C/50 delivered 268 and 243 mAh g⁻¹ anode capacity, respectively. There was capacity delivered across the whole voltage region above ~1.5 V, without noticeable plateaus. This capacity was consistent with a blend of phases of T-Nb₂O₅, anatase, and TiₓNb_{y}O_{z}.

For the 100% MO AAM anode, the first charge and discharge at C/50 delivered 199 and 182 mAh g⁻¹ anode capacity, respectively. The first two plateaus in the charge cycle at 2.18 V and ~2.38 V (cell), were consistent with the reduction of MO into Li_{0.45}MoO₂ via a single-phase reaction mechanism; The plateau at ~2.61 V was attributed to the phase transition from monoclinic phase to orthorhombic phase until Li_{0.78}MoO₂, followed by a two-phase reaction at ~2.76 V back to the monoclinic phase. The first discharge profile exhibited a hysteresis with only two plateaus at ~2.48 V and ~2.18 V, attributed to the two two-phase reactions from monoclinic to orthorhombic and from orthorhombic back to monoclinic.

For the multicomponent AAM electrodes of 75% MO, 50% MO, and 25% MO, as the MO fractions decreased, the first charge and discharge gravimetric capacities linearly decreased as expected because of the lower gravimetric capacity of MO compared to TNO. In the dQ/dV curve, the magnitude of the peaks observed corresponding to the MO material decreased. Besides, the peak positions shifted towards higher overpotentials, which could be explained by (i) the increased ion overpotential from decreased porosity, (ii) the lowered AAM electronic conductivity as MO (higher electronic conductivity compared to TNO) portion decreased, and (iii) the increased effective C-rate for the MO phase when the MO content was decreased while the current was kept the same. Another observation of note was that the 25% MO had overall higher discharge voltage compared to 0% MO, with an increase from 2.17 to 2.24 V. This increase was attributed to the electrode electronic conductivity increase from the MO addition. All AAM TNO/MO electrode full cells had initial coulombic efficiency ranging from 89-92%. The 75% MO had the largest volumetric capacity of 690 mAh cm⁻³ anode (volume basis includes the pore/void volume).

TABLE 2
AAM electrode first cycle electrochemical outcomes.

| | 0% | 25% | 50% | 75% | 100% |
|---|---|---|---|---|---|
| Sample | MO | MO | MO | MO | MO |
| Charge Capacity | 268 | 258 | 241 | 219 | 199 |
| (mAh g⁻¹ anode) | | | | | |
| Discharge Capacity | 243 | 235 | 215 | 200 | 182 |
| (mAh g⁻¹ anode) | | | | | |
| Coulombic Efficiency | 91% | 91% | 89% | 92% | 92% |
| (%) | | | | | |
| Average Discharge | 2.17 | 2.24 | 2.26 | 2.25 | 2.28 |
| Voltage (V) | | | | | |
| Volumetric Discharge | 590 | 650 | 660 | 690 | 660 |
| Capacity | | | | | |
| (mAh cm⁻³ anode) | | | | | |

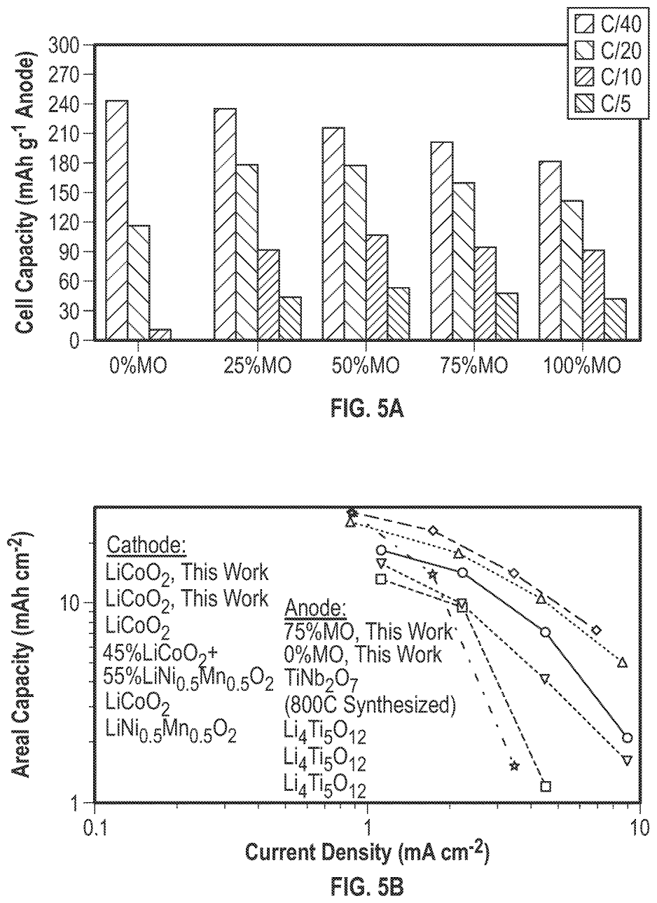

Cell capacity at higher rates for the AAM LCO cathodes paired with the different AAM TNO/MO anodes is summarized in FIG. 5a. The 0% MO had capacity below 120 mAh g⁻¹ anode at C/20, and almost no capacity at higher rates. Such observation was consistent with previous reports, where the limited capacity was attributed to the limited electronic conductivity of the TNO material. For the 25% MO, the capacity at higher rates was much improved. The cell delivered 180 mAh g⁻¹ anode at C/20, and 45 mAh g⁻¹ anode at C/5. For the 50% MO, the capacity at high rates slightly improved compared to 25% MO, but the 75% MO and 100% MO exhibited slightly lower capacity compared to the 50% MO. Such behaviour was similar to other multicomponent AAM cathodes. For example, an AAM electrode composed of 45 wt % LCO (higher electronic conductivity) and 55 wt % LNMO (higher gravimetric capacity) had the best rate capability among materials with varying amounts of LCO/LNMO. In that work, the rate capability improvement was attributed to the formation of a percolated LCO network. The percolation threshold for disordered jammed sphere packing (assumed for the AAM architecture) would be approximately 20 vol %. The volume percentage of MO in 25% MO was ~9.5% and in 50% MO was ~22%, just above the threshold, suggesting the electronic conductivity was no longer the limiting factor for 50% MO, 75% MO, and 100% MO.

FIG. 5b shows the Ragone plot for cells with AAM electrodes from this work and prior reports where the areal capacity at low rate achieved at least 10 mAh cm⁻². In one of those prior works investigating AAM cathodes, a pure LNMO AAM cathode had the lowest areal capacity at all current densities compared to LCO, while multicomponent AAM electrodes of both LCO and LNMO resulted in drastically higher capacity at all rates. This outcome was attributed to the combination of achieving sufficient electronic conductivity via a network of the higher electronic conductivity LCO material, while taking advantage of the higher intrinsic gravimetric capacity of the LNMO material. The LCO, LNMO, and LCO/LNMO AAM cathodes were all paired with LTO AAM anodes. In another previous study, AAM TNO materials were synthesized and treated at different temperatures, and the material processed at 800° C. had the best rate capability when paired with AAM LCO cathode. The 75% MO AAM anode cell had the highest areal capacity at increasing rates of any of the AAM cells both in this work and among those in FIG. 5b. A significant factor contributing to the relatively high capacity retention for this high areal capacity cell was that the increased anode volumetric energy density resulted in ion paths between the cathode and anode that were relatively shorter, improving the energy density at higher rates.

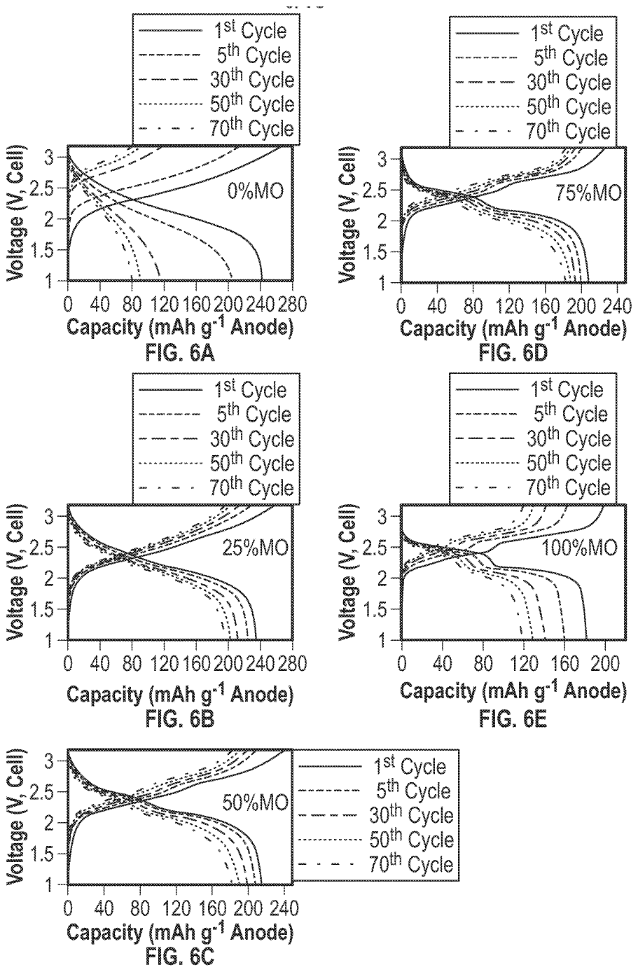

The capacity retention at the 50^{th} cycle for the cells with multicomponent AAM anodes (86% for 25% MO, 89% for 50% MO, and 91% for 75% MO) were much higher than the single component anode cells (37% for 0% MO and 71% for 100% MO). The charge/discharge voltage profiles for the different AAM anodes paired with nominally identical LCO cathodes at 1^{st}, 5^{th}, 30^{th}, 50^{th}, and 70^{th} cycles can be found in FIG. 6. The 0% MO sample (i.e., TNO) had drastic loss of capacity and severely increased polarization (FIG. 6a), and the capacity retention plummeted below 50% at the 28^{th} cycle. The 0% MO was composed of multiple phases. There have been prior reports of capacity fade contributors among these phases, including particle cracking, amorphization, Nb dissolution, SEI formation, and volume change up to 10%. These causes of capacity fade can be exacerbated in AAM electrodes, because if the particle-particle contacts are compromised, electronic conduction pathways through the electrode matrix can be lost, which will result in inaccessible capacity and/or high overpotential. For the other single component electrode, 100% MO (FIG. 6e), the phase change between orthorhombic and monoclinic with cycling has been reported to result in volume change up to 14%. However, the capacity and voltage fade for the 100% MO was less severe than for the 0% MO. It was speculated that much more of the capacity was accessed at a higher voltage region for the 100% MO (for the anode, so >1.2 V vs Li/Li⁺) than the 0% MO, which would result in less of a driving force for excess solid-electrolyte interface (SEI) formation and consequently electrolyte decomposition. Such a degradation process would be somewhat analogous to charging at higher voltages for cathode materials, and has been reported as causing excess capacity loss in high nickel layered oxide cathodes. The 25% MO, 50% MO, and 75% MO in FIGS. 6b-d instead had much suppressed capacity fade. To further investigate the source of stabilization, EIS and P2D simulations were conducted and will be discussed further below.

EIS measurements were conducted on 0% MO, 75% MO, and 100% MO AAM electrodes paired with Li foil. 0% MO and 100% MO were selected to compare the single component electrodes, and 75% MO was chosen as the exemplar multicomponent electrode because it had the highest capacity retention during rate capability evaluation. The mass/thickness of the AAM electrodes were reduced relative to the earlier described cells to mitigate the magnitude of the electrode ionic overpotentials. Note that the areal capacity (~8 mAh cm⁻²) was still much higher compared to conventional composite electrodes, thus cycling was limited to 5 cycles and at C/10 due to the extents of lithium stripping/plating which can consume electrolyte and influence the EIS outcomes. The high-frequency intercept (R_{cell}) and charge-transfer resistance (R_{ct}) were determined from the best fit outcomes and can be found in Table 3. R_{cell} was used to semi-quantitatively assess the relative electronic conductivity of the solid AAM architecture, because the interfacial and diffusional effects were minimal at such high frequencies. Treating the AAM electrode as a transmission line model, the current passage across the electrode was dictated by the relative electronic conductivity of the solid AAM electrode and the ionic conductivity of the liquid electrolyte. The ionic conductivity of the electrolyte during EIS measurements was assumed to stay constant, however, the electronic conductivity of the solid AAM electrode could change by orders of magnitude with lithiation based on prior reports. While the changes in R_{cell} were expected to provide insights into relative changes in AAM electrode electronic conductivity, contributions from other factors, such as irreversible side reactions changing electrolyte concentration during cycling, contact resistance, and contributions from external cell connections, resulted in not pursuing quantitative assessment of the electronic conductivity of the AAM electrodes.

Before electrochemical cycling, the R_{cell} of 100% MO had the lowest value at 3.5Ω, followed by 75% MO at 3.8Ω, and 0% MO at 6.4Ω. This trend was consistent with the electronic conductivity of MO (over 10⁻⁴ S m⁻¹) and TNO (below 10⁻⁴ S m⁻¹) before lithiation. A discussion on estimating R_{cell} can be found in the Supporting Information. The estimated values, considering only the separator and AAM electrode with relevant assumptions on ionic and electronic contributions, were 6.0Ω for 0% MO and 2.4Ω for 75% and 100% MO. The ionic conductivity of the electrolyte used when fabricating the cells was 0.9 S m⁻¹, suggesting the major current carrier was electrolyte for the 0% MO and electronic conduction through the AAM electrode for 100% and 75% MO. After cycling, the R_{cell} of both 100% MO and 75% MO increased, which was suspected to originate from irreversible side reactions that would change the electrolyte concentration and thus change the ionic conductivity as mentioned. The 0% MO R_{cell} decreased as expected due to lithiation, where the electronic conductivity has been reported to increase over 7 orders of magnitude when intercalating Li to a capacity of 20 mAh g⁻¹ TNO.²⁹ Any decrease in ionic conductivity of the liquid electrolyte was not as important relative to the increase in electronic conductivity of the solid AAM electrode.

Before cycling, the 75% MO R_{ct} was greater than the 0% MO and 100% MO. It was speculated this outcome was caused by the denser packing of particles, which resulted in less interfacial area between the AAM electrode and electrolyte. After cycling, the R_{ct} for both the 0% MO and 100% MO decreased, suggesting interfacial activation from cycling. The R_{ct} of 75% MO decreased the most to the lowest R_{ct}. As detailed earlier, the 75% MO had the greatest hardness among the 3 AAM electrode compositions. It was speculated the greater hardness may have mitigated particle cracking or detachment processes, which would result in formation of new interphase (and consequently additional SEI)⁶¹ relative to the 0% MO and 100% MO. To provide further insights into compositional and structural changes in the AAM electrodes, P2D simulations were pursued which also incorporated electrode volume change estimates as a function of electrode discharge and depth.

TABLE 3
R_{cell} and R_{ct} extracted from EIS measurements before
and after cycling on 0% MO, 75% MO, and 100% MO
AAM electrodes paired in cells with Li metal.

| | R_{cell} (Ω) | R_{cell} (Ω) | R_{ct} (Ω) | R_{ct} (Ω) |
|---|---|---|---|---|
| | Before | After | Before | After |
| Sample | Cycling | Cycling | Cycling | Cycling |
| 0% MO | 6.4 | 5.5 | 126 | 24 |
| 75% MO | 3.8 | 4.6 | 142 | 16 |
| 100% MO | 3.5 | 4.5 | 94 | 18 |

### P2D Simulations

P2D simulations were conducted with the system being LCO AAM cathodes paired with 0% MO, 75% MO, and 100% MO AAM anodes to assess the lithiation and volume change distribution across the anodes as a function of depth within the cell during cycling. P2D simulation methods were based on previous reports with AAM electrodes. In brief, for 0% MO, due to the absence of conductive additives, the variable electronic conductivity of TNO as a function of lithiation was used. The use of variable electronic conductivity is a modification for AAM electrodes which is unnecessary for composite electrodes. However, variable electronic conductivity has been shown to be important to capture the charge/discharge curves and lithiation progression for AAM electrode cells for many cases/materials. For the 100% MO, the electronic conductivity was much greater than the ionic conductivity of the liquid electrolyte (matrix electronic conductivity is usually not considered a limiting factor when over 1 S m⁻¹)⁷, so a constant value of 190 S cm⁻¹ was used. For the 75% MO, which contained both MO and TNO phases, the assumption for electronic conductivity was that the high volume percent of MO formed a percolated network which provided matrix electronic conductivity, so the matrix electronic conductivity of the AAM electrode was assumed to be contributed by the relative volume fractions of the MO and TNO (essentially reflecting the electronic conductivity of MO). In addition, herein the volume change of the AAM electrode due to lithiation was assessed. The lattice volume was assumed to have a linear dependence on extent of lithiation. 14% and 10% were assumed for 0.98 and 3.5 mole Li intercalated into the MO and TNO phases, respectively.

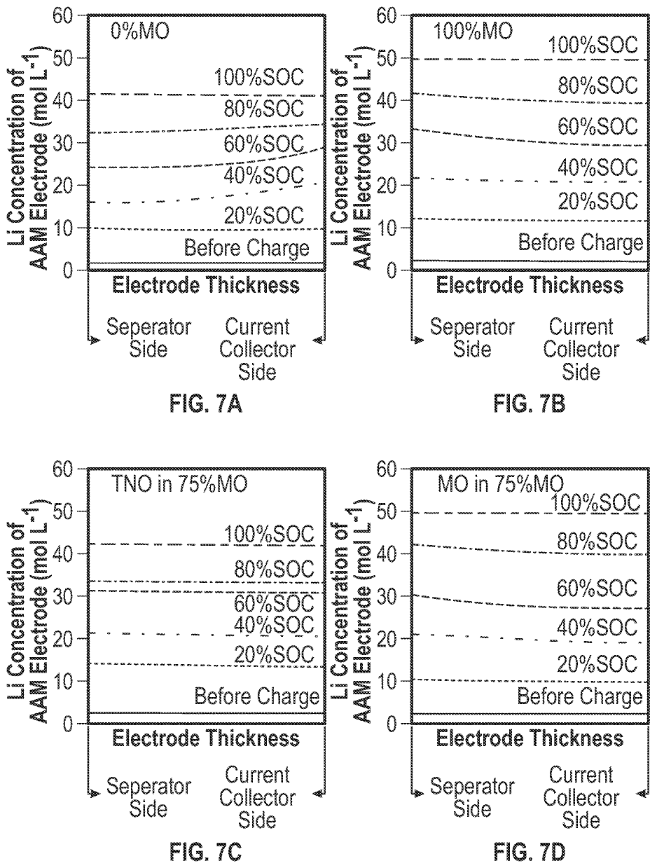

The initial charge cycles for 0% MO, 75% MO, and 100% MO AAM anodes paired with LCO AAM cathodes were simulated using the P2D model. The first charge cycles were chosen for comparison between the simulation outcomes and experiments to exclude factors from cycle fading. The lithium concentration across the cell depth in both the liquid and solid phase at different states of charge can also be extracted from the P2D simulations. The absolute Li concentration profiles in the solid phase (referred to as C_{Li} in later discussion) across the thickness for the AAM anodes during the initial charge at different states of charge can be found in FIG. 7. Each panel in FIG. 7 have an x-axis representing the normalized AAM anode thickness, with left and right sides representing the AAM electrode near the separator and current collector sides, respectively. Analysis of C_{Li} and ΔC_{Li} provides insights into the lithiation behavior during charging for thick AAM electrodes with multiple phases, as well as the distribution of lattice volume changes for the assumptions of their dependence on C_{Li}.

For 0% MO, up to an SOC of 20%, the C_{Li} was homogenous across the electrode. This homogeneity was attributed to the high slope of the open circuit voltage (OCV) as a function of lithiation in the low SOC region for the material. At the relatively low charge current density (0.87 mA cm⁻²), the sloped OCV provided the necessary driving force to more evenly distribute the lithiation, despite the much higher ionic conductivity relative to electronic conductivity in the electrode initially during charge. At 40% SOC, the ΔC_{Li} was about 77% (4.7 mol L⁻¹) higher near the current collector side of the electrode compared to the separator side. This outcome was due to the relatively low electronic conductivity of the solid AAM electrode material relative to the ionic conductivity of the liquid electrolyte. The current will be carried more on the path with lower resistance, and the driving force from OCV was insufficient to even out the Li concentration due to lower OCV slope compared to earlier in the charge cycle. As SOC increased to 60%, the ΔC_{Li} returned to being more homogenous, but C_{Li} still had a gradient with more lithiation near the current collector side, suggesting a balancing of the competition between of OCV driving force and ionic/electronic overpotential at this stage. From 60% OCV until the end of charging the OCV slope increased, resulting in ΔC_{Li} greater at the separator side and C_{Li} returning to being more homogeneously distributed.

For the 100% MO, up until 40% SOC C_{Li} as well as ΔC_{Li} were relatively homogenous due to the highly sloped OCV and high electronic conductivity of the solid AAM electrode. From SOC of 40% to 60%, the OCV was much flatter, which resulted in larger values at the separator side for both C_{Li} and ΔC_{Li}. From 60% SOC until the end of charging, similar to the 0% MO, the ΔC_{Li} was greater on the current collector side because of the increased OCV slope, which corresponded to C_{Li} becoming homogeneous again.

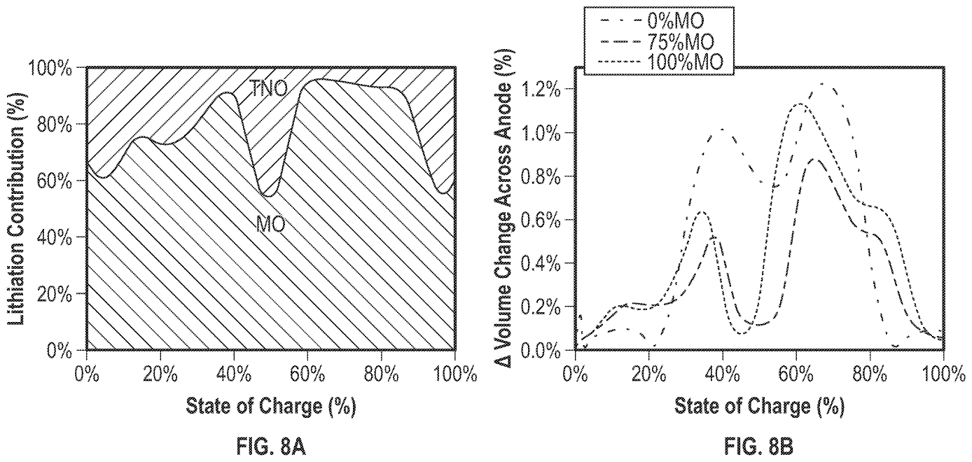

The 75% MO was assumed to have relatively high electronic conductivity from the MO phase. Until 20% SOC (overall AAM electrode basis), the ΔC_{Li} was higher for TNO, because the OCV of TNO at low SOC was higher (vs Li/Li⁺) than that of MO. Both TNO and MO had homogenous ΔC_{Li}, though there was slightly more lithiation on the separator side of the electrode because of the relatively greater electronic conductivity than the ionic conductivity of the liquid electrolyte. As the SOC increased to 40% SOC, the ΔC_{Li} became greater in the MO phase than in the TNO phase, because MO had more capacity in that voltage region intrinsic to the material. Compared to the 100% MO phase at 40% SOC, there was generally slightly more ΔC_{Li} on the separator side, which was attributed to the slightly lower porosity that decreased the effective ionic conductivity of the liquid electrolyte phase, favoring increased current via the solid AAM electrode. Between 40% and 60% SOC, there was more ΔC_{Li} in the TNO again, because in this voltage region, the MO had a sharp OCV change, which resulted much less capacity in the sloped voltage region. In addition, in this voltage region, the OCV of TNO was much flatter, thus providing much more capacity. Between 60% and 80% SOC, the capacity entered the flattest OCV region of MO that resulted in a much higher ΔC_{Li} of the MO phase. Until the end of charge, ΔC_{Li} for both MO and TNO were higher in the current collector region to homogenize the C_{Li} driven by the OCV with increased slopes of both MO and TNO, similar to the previous cases. The ΔC_{Li} of TNO was generally much more homogenous than the MO, because it had more constant OCV slope. In addition, the ΔC_{Li} of TNO was also more homogenous than the 0% MO AAM electrode because of the absence of electronic conductivity limitations. Lithiation contributions from TNO and MO materials in the 75% MO AAM electrode were also plotted FIG. 8a, where TNO had more contributions in the beginning, the middle, and the end, just because of the relative differences in OCV of TNO and MO. TNO filled into the region where MO had sharp OCV changes, especially in the middle of the charge, buffering the time scale for MO phase transition.

For constituent particles in the AAM electrodes, lattice volume expansion and contraction would cause mechanical stress which could result in cracking, new interface formation, or detachment of particles from the solid electrode network. One example of such considerations reported in the literature is core-shell particles, where segregated core and shell regions of different compositions can create voids and/or detach upon cycling due to different rates of expansion and contraction. At the electrode level, especially with such great thickness (all over 400 μm in this work), inhomogeneous expansion/contraction rates across the electrode thickness could also negatively impact the mechanical stability of the electrode. Thus, to analyse the volume change effect on the electrode scale, the C_{Li} at both sides of the AAM electrodes (separator and current collector—corresponding to the starting and ending nodes of the P2D anode simulation region) were extracted from the simulation (another way of viewing the data in FIG. 7).

For 0% MO, the lithiation at the current collector side was higher than the separator side between 20% and 80% SOC. For 100% MO, the lithiation at the current collector side was instead lower than the separator side in SOC of 20-40% and 50-90%. For TNO in 75% MO, the lithiation at the current collector and the separator of the AAM anode were much closer to each other, unlike that in 0% MO. For MO in 75% MO, the lithiation was also greater near the current collector side than the separator side, despite that it happened at about ~10% SOC later than in the 100% MO. Subsequently, the AAM anode volume change was assessed by comparing the volume change at the two ends (separator and current collector side) of the AAM anode. The differences in volume change between the two ends are plotted in FIG. 8b (volume change calculated assuming a linear lattice volume change upon lithiation). For the 75% MO the volume change was averaged using a combination of the values for MO (66.5%) and TNO (33.5%). The better stability of 75% MO was speculated to result from the combination of the lowest peak in Δ volume change (least cycling stress across electrode) and having initially the greatest hardness.

At current densities where ion transport was not the limiting factor in the cell, the magnitude of the Δ volume change was generally dictated by the OCV slope and the relative magnitudes of the electronic conductivity of solid AAM electrode and ionic conductivity of the electrolyte. There are 4 cases to consider. Case I: If the OCV slope is relatively low, and the AAM electronic conductivity is lower than ionic conductivity of electrolyte, stronger lithiation would occur at the current collector side, causing large A volume change across the electrode. Case II: If the OCV slope is relatively low, and the AAM electronic conductivity is higher than ionic conductivity of electrolyte, stronger lithiation would occur at the current collector side, also causing high Δ volume change across the electrode. Case III: If the OCV slope is relatively high, and the AAM electronic conductivity is higher than ionic conductivity of electrolyte, the lithiation would occur homogenously across the electrode, resulting in low Δ volume change across the electrode. Case IV: If the OCV slope is relatively high, and the AAM electronic conductivity is lower, the lithiation would still occur preferentially at the current collector side, but the Δ volume change across the electrode would not necessarily be low, depending on the relative OCV slope and the relative difference between the electronic conductivity of AAM electrode and ionic conductivity of electrolyte.

For thick AAM electrodes, materials with low volume change during charge/discharge are generally desirable. Reducing volume change reduces strain within the electrode microstructure and the possibility of fractures and loss of connectivity within the electrode during cycling. While low volume change is broadly desirable, herein the additional consideration of multicomponent electrodes was discussed. In a multicomponent AAM electrode, combining materials with electrochemical capacity in different voltage regimes, combined with careful consideration of material electronic conductivity, can help alleviate the localization of volume change within the electrode microstructure as a function of depth within the cell. An additional advantage of multicomponent AAM electrodes is the ability to take advantage of high electronic conductivity of one component to enable a lower electronic conductivity material to be used within the percolated network.

Analysing the volume change heterogeneity across the electrode depth using P2D provided additional insights for AAM electrodes during electrochemical cycling, but there are still limitations for these methods. First, the TNO/MO interactions with regards to mechanical and/or chemical properties and interfaces is still unclear. Future work is needed to evaluate the interface that forms between materials in multicomponent AAM electrodes. In addition, validation of the lithiation profiles from the P2D simulations would provide further confidence that they reflected the electrochemical processes. To evaluate the lithiation progression, operando experiments using neutron imaging and XRD will be needed. Finally, the P2D simulations were not capable of capturing three-dimensional (3D) information. More detailed 3D simulations can provide insights into particle orientations and distributions, and anisotropic particle expansion and contraction can be studied, including the assessment of directional mechanical stress/strain.

### P2D Model Description

The model is a pseudo-two-dimensional (P2D) implicit numerical framework, originally proposed by Newman et al.¹⁻³ The following are the governing equations used this work:

### For 0% MO AAM Cathode Cell:

### Electrolyte Concentration:

$${ϵ}_{E} \frac{\partial {c}_{E}}{\partial t} = \frac{\partial }{\partial x} ( {D}_{eff} ( {c}_{E} ) \frac{\partial {c}_{E}}{\partial x} ) + {A}_{TNO} {j}_{TNO} ( 1 - {t}_{+}^{0} )$$

### Electrode Potential:

$$\frac{\partial {ϕ}_{1}}{\partial x} = \frac{- {i}_{1}}{{σ}_{eff} ( {c}_{TNO} )}$$

### Electrolyte Potential:

$$\frac{\partial {ϕ}_{2}}{\partial x} = - \frac{{i}_{2}}{{κ}_{eff} ( c )} + \frac{2 R T}{F} ( 1 + \frac{\partial {ln f}_{\pm } ( {c}_{E} )}{\partial {ln c}_{E}} ) ( 1 - {t}_{+}^{0} ) \frac{\partial {ln c}_{E}}{\partial x}$$

### Lithium Flux Kinetics:

$${j}_{TNO} = - 2 {k}_{TNO} {{c}_{E}^{0.5} ( {c}_{TNO}^{surface} )}^{0.5} {( {c}_{TNO}^{surface} - {c}_{TNO , max}^{surface} )}^{0.5} Sinh ( \frac{F}{R T} ( {ϕ}_{1} - {ϕ}_{2} - {U}_{TNO} ) )$$

Lithium Flux across Electrode & Electrolyte Interface:

$${j}_{TNO} = - {D}_{TNO} \frac{\partial {c}_{TNO}^{surface}}{\partial r}$$

### Electrolyte Current:

$${A}_{TNO} {j}_{TNO} = - \frac{1}{F} \frac{\partial {i}_{2}}{\partial x}$$

### Conservation of Current:

$$I = {i}_{1} + {i}_{2}$$

### Volumetric Surface Area:

$${A}_{TNO} = \frac{3}{{R}_{TNO}} {ϵ}_{TNO}$$

### Electrode Particle Concentration:

$$\frac{\partial {c}_{TNO}}{\partial t} = {D}_{TNO} ( \frac{1}{{r}^{2}} \frac{\partial }{\partial r} ( {r}^{2} \frac{\partial {c}_{TNO}}{\partial r} ) )$$

### Effective Ionic Conductivity and Diffusivity:

$$\frac{{κ}_{eff} ( {c}_{E} )}{κ ( {c}_{E} )} = \frac{{D}_{eff} ( {c}_{E} )}{D ( {c}_{E} )} = {ϵ}_{E}^{α}$$

### Effective Electronic Conductivity:

$${σ}_{eff} ( {c}_{TNO} ) = {σ}_{TNO} {ϵ}_{T N O}^{α}$$

### For 100% MO AAM Cathode Cell:

### Electrolyte Concentration:

$${ϵ}_{E} \frac{\partial {c}_{E}}{\partial t} = \frac{\partial }{\partial x} ( {D}_{eff} ( {c}_{E} ) \frac{\partial {c}_{E}}{\partial x} ) + {A}_{MO} {j}_{MO} ( 1 - {t}_{+}^{0} )$$

### Electrode Potential:

$$\frac{\partial {ϕ}_{1}}{\partial x} = \frac{- {i}_{1}}{{σ}_{eff} ( {c}_{M O} )}$$

### Electrolyte Potential:

$$\frac{\partial {ϕ}_{2}}{\partial x} = - \frac{{i}_{2}}{{κ}_{eff} ( c )} + \frac{2 RT}{F} ( 1 + \frac{\partial ln {f}_{\pm } ( {c}_{E} )}{\partial ln {c}_{E}} ) ( 1 - {t}_{+}^{0} ) \frac{\partial ln {c}_{E}}{\partial x}$$

### Lithium Flux Kinetics:

$${j}_{M O} = - 2 {k}_{M O} {{c}_{E}^{0.5} ( {c}_{M O}^{surface} )}^{0.5} {( {c}_{M O}^{surface} - {c}_{MO , max}^{surface} )}^{0.5} Sinh ( \frac{F}{R T} ( {ϕ}_{1} - {ϕ}_{2} - {U}_{M O} ) )$$

Lithium Flux across Electrode & Electrolyte Interface:

$${j}_{MO} = - {D}_{MO} \frac{\partial {c}_{M O}^{surface}}{\partial r}$$

### Electrolyte Current:

$${A}_{MO} {j}_{MO} = - \frac{1}{F} \frac{\partial {i}_{2}}{\partial x}$$

### Conservation of Current:

$$I = {i}_{1} + {i}_{2}$$

### Volumetric Surface Area:

$${A}_{M O} = \frac{3}{{R}_{M O}} {ϵ}_{M O}$$

### Electrode Particle Concentration:

$$\frac{\partial {c}_{M O}}{\partial t} = {D}_{M O} ( \frac{1}{{r}^{2}} \frac{\partial }{\partial r} ( {r}^{2} \frac{\partial {c}_{M O}}{\partial r} ) )$$

### Effective Ionic Conductivity and Diffusivity:

$$\frac{{κ}_{eff} ( {c}_{E} )}{κ ( {c}_{E} )} = \frac{{D}_{eff} ( {c}_{E} )}{D ( {c}_{E} )} = {ϵ}_{E}^{α}$$

### Effective Electronic Conductivity:

$${σ}_{eff} ( {c}_{M O} ) = {σ}_{M O} {ϵ}_{M O}^{α}$$

### For Blended 75% MO AAM Cathode Cell:

### Electrolyte Concentration:

$${ϵ}_{E} \frac{\partial {c}_{E}}{\partial t} = \frac{\partial }{\partial x} ( {D}_{eff} ( {c}_{E} ) \frac{\partial {c}_{E}}{\partial x} ) + ( {A}_{TNO} {j}_{TNO} + {A}_{MO} {j}_{MO} ) ( 1 - {t}_{+}^{0} )$$

### Electrode Potential:

$$\frac{\partial {ϕ}_{1}}{\partial x} = \frac{- {i}_{1}}{{σ}_{eff} ( {c}_{TNO} , {c}_{M O} )}$$

### Electrolyte Potential:

$$\frac{\partial {ϕ}_{2}}{\partial x} = - \frac{{i}_{2}}{{κ}_{eff} ( c )} + \frac{2 RT}{F} ( 1 + \frac{\partial ln {f}_{\pm } ( {c}_{E} )}{\partial ln {c}_{E}} ) ( 1 - {t}_{+}^{0} ) \frac{\partial ln {c}_{E}}{\partial x}$$

### Lithium Flux Kinetics:

$${j}_{TNO} = - 2 {k}_{TNO} {{c}_{E}^{0.5} ( {c}_{TNO}^{surface} )}^{0.5} {( {c}_{TO}^{surface} - {c}_{TNO , max}^{surface} )}^{0.5} Sinh ( \frac{F}{RT} ( {ϕ}_{1} - {ϕ}_{2} - {U}_{TNO} ) )$$

$${j}_{MO} = - 2 {k}_{M O} {{c}_{E}^{0.5} ( {c}_{M O}^{surface} )}^{0.5} {( {c}_{M O}^{surface} - {c}_{M O ,}^{surface} )}^{0.5} Sinh ( \frac{F}{R T} ( {ϕ}_{1} - {ϕ}_{2} - {U}_{M O} ) )$$

Lithium Flux across Electrode & Electrolyte Interface:

$${j}_{TNO} = - {D}_{TNO} \frac{\partial {c}_{TNO}^{surface}}{\partial r}$$

$${j}_{MO} = - {D}_{MO} \frac{\partial {c}_{M O}^{surface}}{\partial r}$$

### Electrolyte Current:

$${A}_{TNO} {j}_{TNO} + {A}_{MO} {j}_{MO} = - \frac{1}{F} \frac{\partial {i}_{2}}{\partial x}$$

### Conservation of Current:

$$I = {i}_{1} + {i}_{2}$$

### Volumetric Surface Area:

$${A}_{TNO} = \frac{3}{{R}_{TNO}} {ϵ}_{TNO}$$

$${A}_{M O} = \frac{3}{{R}_{M O}} {ϵ}_{MO}$$

### Electrode Particle Concentration:

$$\frac{\partial {c}_{LCO}}{\partial t} = {D}_{LCO} ( \frac{1}{{r}^{2}} \frac{\partial }{\partial r} ( {r}^{2} \frac{\partial {c}_{LCO}}{\partial r} ) )$$

$$\frac{\partial {c}_{LNMO}}{\partial t} = {D}_{LNMO} ( \frac{1}{{r}^{2}} \frac{\partial }{\partial r} ( {r}^{2} \frac{\partial {c}_{LNMO}}{\partial r} ) )$$

### Effective Ionic Conductivity and Diffusivity:

$$\frac{{κ}_{eff} ( {c}_{E} )}{κ ( {c}_{E} )} = \frac{{D}_{eff} ( {c}_{E} )}{D ( {c}_{E} )} = {ϵ}_{E}^{α}$$

### Effective Electronic Conductivity (Perfect Percolation Assumed):

$${σ}_{eff} ( {c}_{TNO} , {c}_{MO} ) = {σ}_{TNO} {ϵ}_{TNO}^{α} + {σ}_{MO} {ϵ}_{M O}^{α}$$

| List of Symbols | |
|---|---|
| Electronic Conductivity | σ |
| Ionic Conductivity | κ |
| Liquid Li⁺ Concentration | c_{E} |
| Solid Li⁺ Concentration in TNO | c_{TNO} |
| Solid Li⁺ Concentration in MO | c_{MO} |
| Solid Potential | Φ₁ |
| Liquid Potential | Φ₂ |
| Volume Fraction | ε |
| Li⁺ Intercalation | j |
| Open Circuit Potential | U |
| Discharge Current Density | I |
| Solid Phase Current Density | i₁ |
| Liquid Phase Current Density | i₂ |
| Volumetric Solid Particle Surface Area | A |
| LCO Solid Particle Radius | R_{TNO} |
| MO Solid Particle Radius | R_{MO} |
| Electrolyte Diffusivity | D |
| Solid State Diffusivity | Dₛ |
| Bruggeman Exponent | α |
| Transference number | t⁰₊ |
| Faraday Constant | F |
| Temperature | T |
| Gas Constant | R |

### Example 2

### Electroactive Material Powder Synthesis

The synthesis of LiCoO₂ (LCO) electroactive material powder was based on a previously reported method of oxalate precursor precipitation followed by solid state reaction. 200 mM of cobalt sulfate heptahydrate (CoSO₄·7H₂O, Acros Organics) and 200 mM of sodium oxalate (Na₂C₂O₄, Fisher) were separately dissolved into 2 beakers of 400 mL of deionized (DI) water each and preheated to 60° C. The sulfate solution was poured all at once into the oxalate solution, and the solution was kept at 60° C. with stirring at 300 RPM for half an hour. The resulting precipitate was collected via vacuum filtration, followed by 1.6 L of DI water rinsing, before being transferred to an oven and dried at 80° C. overnight in air. The dried powder was then blended with lithium carbonate (Li₂CO₃, Fisher Chemical) by hand with target Li:Co stoichiometry of 1.05:1 using a mortar and a pestle for 10 min. The mixed powder was placed in a crucible and heated up to 800° C. at a ramp rate of 1° C. min⁻¹ in air without a hold. The furnace was then allowed to cool to room temperature without control over cooling rate.

TNO electroactive material precursor was synthesized using a sol-gel method. Briefly, 0.5 M of niobium chloride (NbCl₅, Fisher) was dissolved in 40 mL of ethanol at 40° C. and stirred at 300 RPM, followed by addition of 0.25 M of titanium isopropoxide (Ti(OC₃H₇)₄, Sigma-Aldrich) to the same solution. When the solution became fully transparent (typically <30 seconds), it was poured into a drying dish and dried at room temperature overnight in air. The resulting gel was redissolved in 40 mL deionized (DI) water using a spatula for mixing by hand until fully dissolved, and then dried at 80° C. overnight in air within a fume hood. The dried precursor was then ground using mortar and pestle by hand for 5 mins and heated in a furnace in air with ramp rates for heating and cooling of 1° C. min⁻¹. The highest target temperature and hold time at that target was 1000° C. for 24 h, 800° C. for 2 h, 700° C. for 2 h, and 600° C. for 2 h (referred as 1000 C, 800 C, 700 C, and 600 C, respectively, when referenced herein). Note the holding time for the 1000 C was longer than the other materials at 24 h to pursue one sample with high phase purity and crystallinity

### Composite Electrode Fabrication

All cathodes in composite cells were composite TNO electrodes. The 1000 C, 800 C, 700 C, and 600 C powder was blended with acetylene carbon black (CB, Alfa Aesar) as conductive additive and 3.33 wt % polyvinyl pyrrolidone (PVP, Sigma Aldrich, 360 kDa molecular weight) as polymer binder with a TNO:PVP:CB weight ratio of 8:1:1. The slurry mixture was then casted onto an aluminum foil current collector using a doctor blade with a gap of 200 μm, and areal electroactive material loadings were 0.9-2.0 mg cm⁻² after drying. Circular electrodes with an area of 1.33 cm² were punched by hand using a die and transferred into a glove box filled with argon.

All anodes in composite cells were Li foils with thicknesses of 100 μm and punched into circular shape with an area of 1.6 cm².

### AAM Electrode Fabrication

All cathodes in AAM cells were AAM LCO electrodes. 1.0 g of LCO powder was blended with 2.0 mL of 1.0 wt % PVB solution in ethanol using a mortar and a pestle by hand until dried. The coated LCO powder was transferred into a circular pellet die (Carver) with an area of 1.33 cm², followed by pressing at 420 MPa for 2 min using a hydraulic press (Carver). The mass of PVB-coated LCO was targeted to be 350 mg for each electrode pellet. The pressed LCO pellet was then AAM in air at 600° C. for 1 hour with ramp rates of 1° C. min⁻¹ for both heating and cooling. The as-prepared pellets had measured thicknesses ranging between 770-800 μm, areal loadings of 253-258 mg cm⁻², and geometric pore/void fractions of 0.32-0.34 (calculated assuming the crystal density to be 5.0 g cm⁻³).

All anodes in AAM cells were AAM TNO electrodes. The coating and pressing were the same procedure as used for LCO. During the thermal treatment of the pressed TNO pellets, the top target temperature was 1000° C., 800° C., 700° C., and 600° C. for the 1000 C, 800 C, 700 C, and 600 C source powders, respectively. In all cases the hold at the target temperature was 2 h and the heating and cooling ramp rates were 2° C. min⁻¹. Resulting TNO pellets had measured thicknesses of 440-450 μm, areal loadings of 109-110 mg cm⁻², and geometric pore/void volume fractions of 0.40-0.41.

AAM electrodes for electrochemical impedance spectroscopy (EIS) evaluation were fabricated using the same processing conditions as described above, except that the areal loading was reduced to accommodate the use of lithium foil as the other electrode. The resulting areal loadings were 36-37 mg cm⁻², and measured thicknesses were 140-150 μm.

### Material Characterization and Electrochemical Evaluation

Powder X-ray diffraction (XRD) was performed using a PANalytical X′pert ProMPD. Scanning electron micrographs (SEM) were collected using a FEI quantum 650.

All electrochemical cell assembly was performed in a glove box with water and oxygen levels <1 ppm. All cells used 2032-type coin cell parts. For composite cells, Celgard 2325 with an area of 1.98 cm² was used as separator, and electrolyte was 1.2 M LiPF₆ in 3:7 ethylene carbonate:ethyl methyl carbonate (Gotion). The assembled cells were evaluated using a multichannel battery cycler (MACCOR) between 1.0-2.5 V (vs. Li/Li⁺) at C/10, where 200 mAh g⁻¹ TNO was assumed for calculating C rates and the current was adjusted based on measured TNO mass loading in the electrodes.

For AAM cells, the as prepared LCO and TNO pellet electrodes were adhered to the bottom plate and the spacer of the 2032-type coin cell, respectively, using a custom carbon paste to reduce contact resistance. The carbon paste consisted of 4.76 wt % of CB, 4.76 wt % of PVP, and 90.48 wt % of ethanol. After attaching the pellets, they were dried in vacuum at 80° C. for 20 min to remove ethanol before transferring into the glove box. Electrolyte was the same used in composite cells, but glass fiber (Fisher, type G6 circles) with an area of 1.98 cm² was used as separator for AAM electrode cells. 0.85 mA cm⁻² was assumed to be C/50 for all AAM cells. The mass ratio of LCO:TNO was ~2.5:1, resulting in what was expected to be anode limited cells for all cases.

AAM cells used in EIS experiments were attached to the current collector using the same procedure described above with CB conductive paste. Δ difference for the EIS cells was the separator, where 2 layers of Celgard 2325 were used as separator. Also, the AAM TNO was the cathode/working electrode in the EIS cells, where Li foil was used as the anode (and reference/counter electrode). EIS evaluate was conducted right after cell assembly, and also at 4 states of discharge at 1.6 V, 1.4 V, 1.2 V, and 1.0 V. For each voltage, the cell was discharged at a constant current of C/10 (0.77 mA cm⁻¹) to the target voltage, followed by a hold at constant voltage at the target set voltage for 20 h to minimize any inhomogeneity in Li distribution across the AAM electrode. After the 20 hours at constant voltage, another EIS measurement was conducted before initiating the next discharge step. EIS experimental parameters were extracted by fitting the data using Zview software.

Electronic conductivity of AAM electrodes before cycling were measured by sandwiching the porous pellet between nickel foam electrodes. A direct current (DC) was measured for a constant applied voltage of 0.1 V. The current was used to calculate the AAM pellet resistance and subsequently electronic conductivity, with the value corrected by assuming a Bruggeman exponent of 1.5³³.

### Results and Discussions

### Materials Characterization

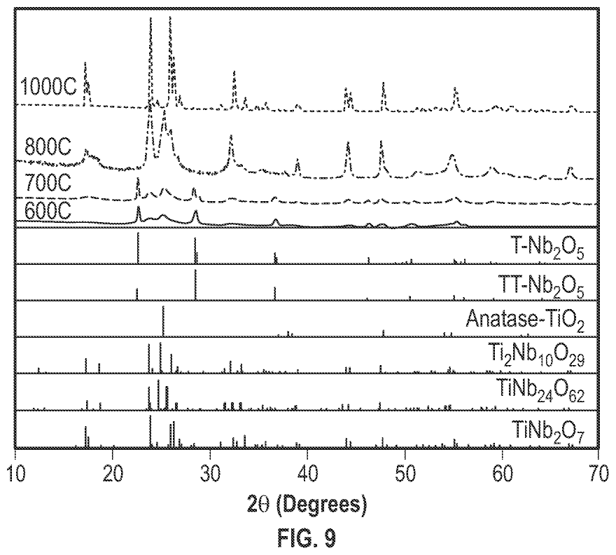

The XRD patterns for all four synthesized TNO materials are shown in FIG. 9. For the 1000 C sample, at this highest temperature synthesis there were no impurity phases observed and the XRD pattern aligned well with the reference patterns for monoclinic C2/m.²² The 800 C sample exhibited broader peaks in the XRD pattern suggesting lower crystallinity, and there were impurity peaks observed which were consistent with a blend of other phases of titanium niobates and anatase TiO₂. The 700 C sample possessed major phases assigned as T-Nb₂O₅ (NBO, orthorhombic, pbam) and anatase TiO₂, while the minor contributing phases were consistent with multiple titanium niobates. The 600 C sample compared to the 700 C sample had slightly lower crystallinity, with TT-NBO (pseudohexagonal, −p62) consistent with the peaks of the major contributing phase as opposed to T-NBO. Although many of these materials were found to have a blend of Ti and Nb phases, “TNO” was still used to broadly denote this blend of phases for all samples (even for lower temperature processed materials).

The 1000 C sample had large internal porosity, and the primary particles were distinct and exhibited particle size of ~700 nm. The 800 C sample had slightly less distinguishable internal voids in the secondary aggregates, and the primary particles were much smaller, in the ~100 nm range. The 700 C and 600 C samples appeared similar, and the surface of the secondary particle aggregates was smoother with less defined pore regions compared to the 800 C and 1000 C samples. The primary particles did not have pronounced morphology, which possibly originated from the low crystallinity in these materials and would be consistent with the XRD results. The pellet surfaces for all samples were flat due to the hydraulic compression step, and the primary particle morphologies were not changed noticeably relative to the source powders.

The electronic conductivities of the AAM electrodes after fabrication are shown in Table 4. The 1000 C phase pure material had the lowest electronic conductivity of 6.2×10⁻¹¹ S cm⁻¹, which was consistent with the reported literature range of 10⁻⁹-10⁻¹¹ S cm⁻¹. The 800 C AAM electrode was similar to the 1000 C, but the 700 C and 600 C had increased electronic conductivity, which could be attributed to the higher electronic conductivity of the NBO phase contributions which have orders of magnitude reported higher conductivities.

TABLE 4
Electronic conductivity of the AAM porous electrode pellets.

| Sample | 600 C | 700 C | 800 C | 1000 C |
|---|---|---|---|---|
| Electronic | 1.4 × 10⁻¹⁰ | 9.3 × 10⁻¹¹ | 6.5 × 10⁻¹¹ | 6.2 × 10⁻¹¹ |
| Conductivity | | | | |
| (S cm⁻¹) | | | | |

### Composite Electrode Cell Characterization

TABLE 5
Summary of electrochemical evaluation of composite TNO cathodes
paired with Li foil anodes. The first and last cycles were at
a rate of C/10 with resulting current density of 18-40 μA cm⁻².

| | 600 | 700 | 800 | 1000 |
|---|---|---|---|---|
| Sample | C | C | C | C |
| First Charge Cycle Average | 1.69 | 1.64 | 1.62 | 1.58 |
| Voltage (V, vs Li/Li⁺) | | | | |
| First Charge Cycle Capacity | 190 | 259 | 233 | 258 |
| (mAh g⁻¹ TNO) | | | | |
| First Cycle Coulombic | 82% | 90% | 88% | 94% |
| Efficiency (%) | | | | |
| Last (30^{th}) Charge Cycle | 95% | 84% | 84% | 68% |
| Capacity Retention (%) | | | | |

When processed into a targeted full cell, TNO served as the anode material. In the context of the full cell, the analysis was more focused on the discharge cycle. The full cell discharge involved oxidation of the TNO materials, which corresponded to the charge cycle in the half cells with TNO cathodes paired with Li metal anodes. Thus, the following discussion of results for half cells with TNO material paired with Li metal anodes focused on the charge cycle. Selected relevant data can be found in Table 5.

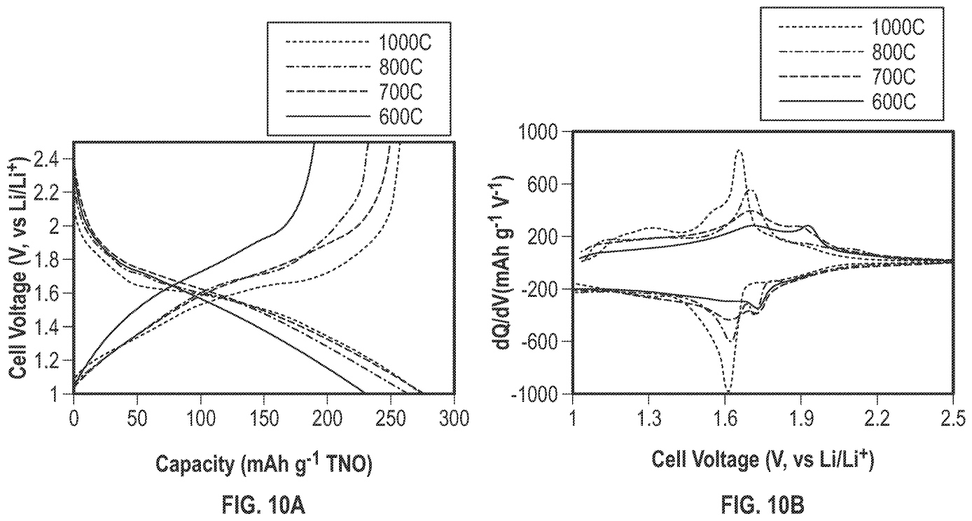

First cycle discharge and charge voltage profiles for TNO composite electrodes paired with Li foil anodes at rates of C/10, and the corresponding dQ/dV profiles from those cycles, can be found in FIG. 10. The first charge delivered 258 mAh g⁻¹ TNO with an initial columbic efficiency (CE) of 94% for the 1000 C material. The first charge and discharge voltage profile for the 1000 C TNO electrode included three regions. There were two sloped regions, one below ~1.5 V and one above ~1.6 V, and a plateau region in between. Correspondingly, a prominent major dQ/dV peak was observed at ~1.65 V and the rest of the voltage regions had much lower capacity. These electrochemical outcomes at relatively low charge/discharge rates were consistent with previous reports for TNO materials with high crystallinity, which has been attributed to the simultaneous redox of Ti⁴⁺/Ti³⁺ and Nb⁵⁺/Nb³⁺. The 30^{th} (last) charge cycle capacity retention was relatively low at only 67.5%, which was speculated to result from the large volume change of 6-10% for TNO with high crystallinity during cycling.

For the 800 C TNO material, the first charge achieved 259 mAh g⁻¹ TNO with an initial CE of 88%. During the first discharge there were two small voltage plateaus at ~1.7 V, and correspondingly two dQ/dV peaks were observed. The smaller dQ/dV peak which appeared at ~1.75 V was not observed in the 1000 C sample. The following charge cycle had a relatively broad and shallow peak at ~1.9 V. Combining the dQ/dV peak position with the low reversibility, we speculated that the capacity originated from the Ti⁴⁺/Ti³⁺ redox in the TiO₂ phase, which would have been consistent with previous reports. The 30^{th} charge cycle capacity retention (83.6%) was much higher relative to the 1000 C sample.

For the 700 C sample, the first charge achieved 233 mAh g⁻¹ TNO with an initial CE of 90%. The capacity was more evenly distributed throughout the voltage window. In the dQ/dV plot, as was the case for the 800 C material, there were two peaks (at ~1.75 V and ~1.60 V) from the discharge cycle. Compared to the dQ/dV of the 800 C sample, the first discharge peak at ~1.75 V initiated at a higher voltage and the peak was broader. Also, in comparison to the 800 C material the second peak from discharge at ~1.60 V had smaller intensity and was much broader, and the dQ/dV plot had greater absolute values in the regions outside the peaks as well. These observations were consistent with previous electrochemical reports for T-NBO. The last charge cycle capacity retention (84.4%) was improved compared to the 800 C sample.

For the 600 C sample, the first charge achieved 190 mAh g⁻¹ TNO with an initial CE of 82%. This outcome of much lower capacity relative to the other TNO materials may have been due to the low crystallinity of the material and/or the inherent smaller capacity of the contributing phase of TT-NBO. In addition, the discharge profile had a significant slope with only a very shallow plateau observed. The last charge cycle capacity retention (94.8%) was the highest of any of the materials evaluated. TT-NBO material had low lattice volume change with lithiation compared to the other phases discussed above, and this low volume change may have been the source of the increased cycling stability compared to even materials that had the T-NBO phase.

In brief, as the synthesis temperature decreased, the last charge cycle capacity retention increased, which may have resulted from the lower volume change of the phases formed during the lower temperature processing. However, these materials with lower crystallinity and blended oxide phases had lower first cycle CE and higher average charge voltage, which would lower the discharge voltage if used as an anode in a full cell.

### AAM Electrode Cell Characterization

TABLE 6
Summary of electrochemical evaluation of AAM TNO anodes paired
with AAM LCO cathodes. The first and last cycles were at a rate
of C/50 with resulting current density of 0.85 mA cm⁻².

| | 600 | 700 | 800 | 1000 |
|---|---|---|---|---|
| Sample | C | C | C | C |
| First Discharge Average | 2.12 | 2.23 | 2.25 | 2.33 |
| Voltage (V, cell) | | | | |
| First Cycle Voltage Efficiency (%) | 85% | 90% | 91% | 93% |
| First Discharge Capacity | 234 | 233 | 231 | 249 |
| (mAh g⁻¹ TNO) | | | | |
| First Cycle Coulombic | 88% | 89% | 92% | 94% |
| Efficiency (%) | | | | |
| Last (25^{th}) Discharge | 79% | 95% | 91% | N/A |
| Cycle Capacity Retention (%) | | | | |
| Last (25^{th}) Discharge | 77% | 91% | 85% | N/A |
| Cycle Energy Retention (%) | | | | |

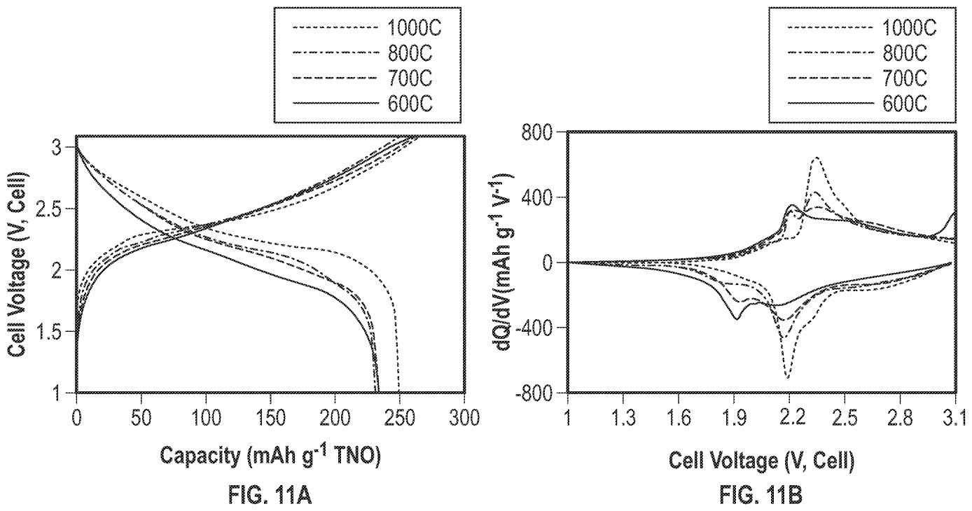

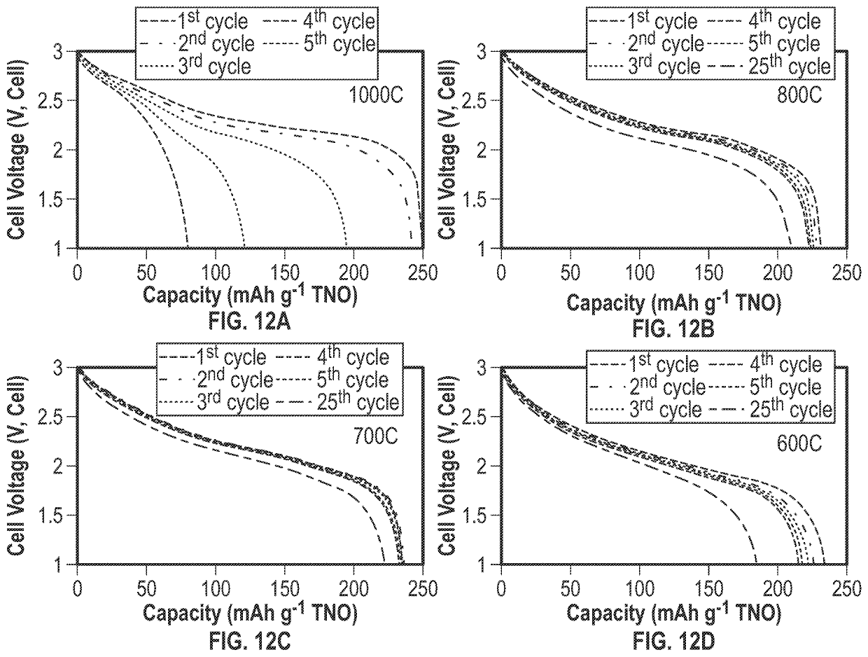

The first charge and discharge voltage profiles at C/50 and corresponding dQ/dV plots for AAM cells with TNO material anodes paired with LCO cathodes can be found in FIG. 11, and selected data of interest are presented in Table 6. The 1000 C sample had the largest discharge capacity of 249 mAh g⁻¹ TNO with the highest average discharge voltage (2.33 V, cell). The 1000 C TNO also had the highest first cycle coulombic efficiency (94%) and voltage efficiency (93%). The TNO was paired with LCO which has a sloped OCV, compared to the approximately fixed OCV of Li metal. However, the shape of the dQ/dV was still consistent with the composite dQ/dV. For the AAM cell, in evaluating the corresponding initial first discharge of the composite cell, a single large peak was observed in dQ/dV. This peak was broad which was attributed to factors such as increased ionic overpotentials for the AAM electrodes and the sloped OCV of the LCO. Generally, the peak location was consistent with expectations based on the composite dQ/dV outcomes. However, there were dramatic stability limitations for the 1000 C TNO AAM anode cells in later cycles. As can be seen in FIG. 12a, after the first five cycles at C/50 the discharge capacity plummeted from ~250 mAh g⁻¹ TNO to only ~80 mAh g⁻¹ TNO and the average voltage also declined. Such severe capacity fading was not observed in the composite cell with 1000 C TNO. One possibility for these different outcomes with regards to cycling stability for composite versus AAM electrodes for the same materials may have been due to mechanical failure of the AAM electrode. For AAM electrode architecture, mechanical integrity of the electrode was provided by the interconnected particles of the electroactive material. TNO has been reported to undergo 6-10% volume change during cycling, which was a relatively large volume change compared to other reported AAM electrode materials such as LTO or LCO. Failure from excessive strain and particle fracture within AAM electrodes would result in loss of particle connectivity and matrix electronic conductivity. The capacity and voltage fade were much smaller for the first 5 cycles between 1.0-2.7 V, where an initial discharge capacity of ~190 mAh g⁻¹ TNO was reached and degraded to ~175 mAh g⁻¹ TNO. An additional 5 cycles between 1.0-2.8 V increased the rate of capacity fade, where the discharge capacity dropped from ~190 mAh g⁻¹ TNO to ~75 mAh g⁻¹ TNO. It was speculated that the additional lithiation likely caused more volume change in the TNO anode due to the additional lithiation forced by the increased charge potential. The 1000 C sample with high crystallinity was not a suitable material for AAM electrodes due to dramatic capacity fade.

For the 800 C TNO AAM anode, the first discharge delivered a capacity of 231 mAh g⁻¹ TNO with an average discharge voltage of 2.25 V (cell). The first cycle voltage efficiency and CE were 91%, and 92%, respectively, both slightly lower than those of the 1000 C material. In the dQ/dV plot, the first charge had two peaks but the first discharge had only one peak, consistent with the composite TNO anode dQ/dV outcomes. The stability with more extended cycling of this sample was much improved relative to the 1000 C material with a capacity retention of 91% and energy retention of 85% after 25 cycles, compared to the 1000 C sample that quickly lost capacity.

For the 700 C sample, the first discharge for the AAM electrode full cell delivered 233 mAh g⁻¹ TNO capacity with an average voltage of 2.23 V. The first cycle voltage efficiency and CE were 90%, and 89%, respectively, both slightly lower than the 800 C AAM TNO anode cell. The quantity and location of peaks in the dQ/dV profile were similar to those observed in the 800 C composite cell (when accounting for the offsets with regards to the potentials for the different electrodes involved). The charge/discharge cycling capacity retention/stability was the highest among the AAM TNO anodes evaluated, with a capacity retention of 95% and energy retention of 91% at 25^{th} cycle. As mentioned earlier, the volume change during cycling was speculated to be a critical factor to AAM electrode cycling stability. The primary phase assigned to the 700 C TNO material was T-NBO, with volume change reported after lithiation to be around 2-3%, much smaller than the volume change reported for the higher temperature TNO phase (TiNb₂O₇) with higher crystallinity. The reduced volume change for the T-NBO phase in the 700 C TNO electrode was suspected to result in the increased observed cycling stability.

For the 600 C material, at the end of the first charge another voltage plateau appeared (also shown in the dQ/dV plot). This outcome was attributed to the inherently lower capacity of this material compared to the other TNO materials, and may have resulted from overlithiating the anatase and/or TT-NBO phases. Such overlithiation has been reported to destabilize the electrode architecture and create unfavorable solid electrolyte interphase (SEI). The initial intent was not to utilize the capacity at voltages where SEI formation would be significant, but in order to characterize and compare more thoroughly with the other three materials, the same relative loadings and voltage windows were used to maintain comparisons. The 600 C TNO first discharge capacity reached 234 mAh g⁻¹ TNO and average voltage was 2.12 V, with voltage being the lowest among all AAM TNO anode materials evaluated. For the first cycle, it also had the lowest voltage efficiency and CE of 85% and 88%, respectively. The cell with the 600 C anode material had the lowest capacity retention of 79% and energy retention of 77% at the 25^{th} cycle relative to the other TNO materials. Even though in the conventional composite cell the 600 C material had the best capacity retention, the same 600 C in an AAM electrode had the worst capacity retention. This outcome likely resulted from keeping the voltage window the same for all AAM cells for comparison between materials. This resulted in the 600 C AAM electrode having much more capacity than the 600 C material in a composite electrode (234 mAh g⁻¹ TNO compared to 190 mAh g⁻¹ TNO in conventional composite electrode). This extra capacity for the AAM electrode likely caused further mechanical stress on the material, and because it must be extracted by pushing the material to lower voltages extra electrolyte decomposition would also be expected relative to the composite electrode.

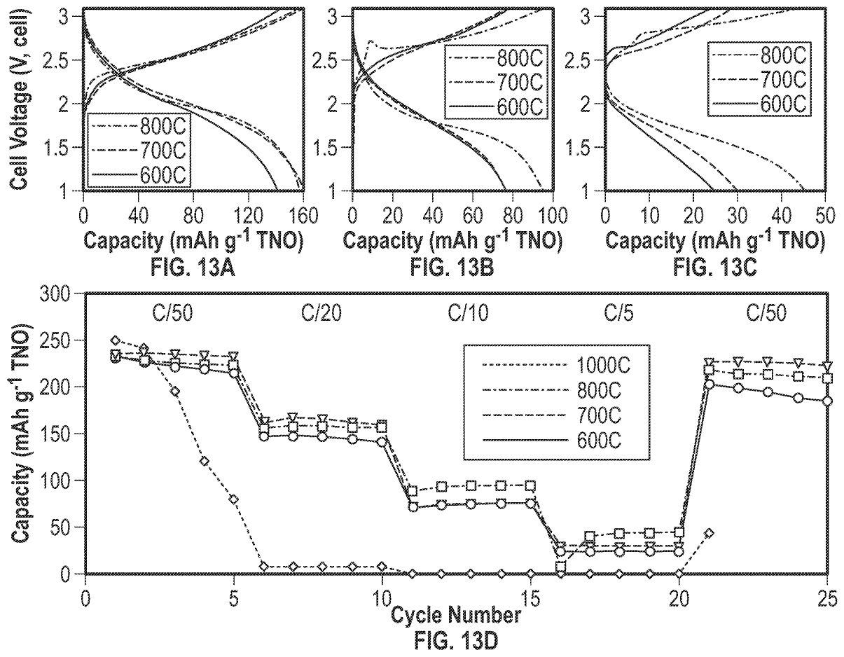

The rate capabilities up to a rate of C/5 with the corresponding voltage profiles for cells with AAM anodes at 600 C, 700 C, and 800 C, can be found in FIG. 13. 1000 C was not shown due to severe fade in the prior C/50 cycles. For electrodes with such high loading and thickness, the greatest contributor to cell overpotential and physical property which limited achieving high capacity/utilization of the electroactive material in the cell was not from the Li⁺ solid state diffusion and/or interfacial kinetics. Instead, ionic conductivity and diffusivity in the electrolyte phase was the main source of resistance within the cell, although for relatively low electronic conductivity materials such TNO electronic conduction through the electrode matrix can also be a major contributor to cell polarization. Phase pure TNO before any lithiation had much lower electronic conductivity than unlithiated NBO; however, after initial lithiation of ~50 mAh g⁻¹ TNO the electronic conductivity increased dramatically and exceeded that of the comparably lithiated (on gravimetric capacity basis) T-NBO. Further lithiation resulted in a decreased electronic conductivity of TNO, but a slightly increasing electronic conductivity for the NBO material, resulting in NBO overtaking TNO and having a higher electronic conductivity at the higher extents of lithiation. Anatase phase had generally the lowest electronic conductivity of the three materials, although the electronic conductivity also had an increase with lithiation of the material. The highest value for the electronic conductivity for the anatase was less than 10⁻⁵ S cm⁻², which would not have been desirable for any of the AAM electrode materials.

Overall, the 800 C AAM TNO anode cell had the best rate capability, followed by the 700 C and 600 C materials at the highest rates of C/10 and C/5. This outcome was suspected to have resulted from the decreased crystallinity and increased anatase fractions with reduced electronic conductivity for the materials processed at the lower temperatures. For the 800 C sample at C/20, C/10, and C/5 (especially at C/10), a very large overpotential was noted early in the charge cycles. This observation was speculated to result from the enriched TiNb₂O₇ phase (and other Ti and Nb containing oxides) in the 800 C sample and more NBO phases in the 700 C and 600 C sample, where before lithiation the TiNb₂O₇ phase would have lower electronic conductivity, but at higher states of lithiation the phase would become much more electronically conductive compared to the NBO phases at the lower temperatures. Another piece of evidence to support this speculation was that at the 16^{th} cycle (first C/2.5 cycle), the capacity was only ~9 mAh g⁻¹ TNO and increased to over 40 mAh g⁻¹ TNO at later cycles. One explanation for this outcome could be that in the 16^{th} cycle only a tiny amount of lithiation (~1.5 mAh g⁻¹ TNO) was added, which would have increased the electronic conductivity in the matrix and facilitated further lithiation for the later cycles. It is noted that in the context of this analysis TT-NBO electronic conductivity as a function of lithiation data was not available, and thus was assumed to be similar to T-NBO.

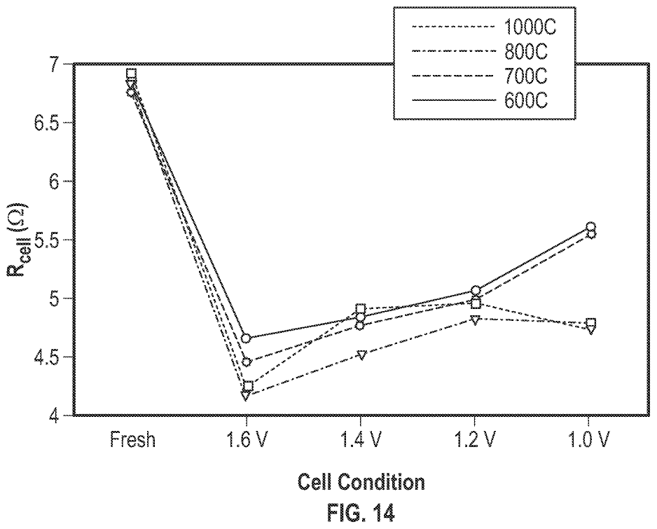

EIS analyses were conducted for AAM TNO electrodes paired with Li metal electrodes at decreasing holding voltages. The high frequency intercepts (R_{cell}) extracted for the freshly prepared cells, and at the holding voltages of 1.6 V, 1.4 V, 1.2 V, and 1.0 V (vs Li/Li⁺) were used to provide semi-quantitative insights into the electronic conductivity of the AAM electrodes (FIG. 14). The use of R_{cell} was intended to focus on changes that might result due to the AAM electrode relative changes in electronic conductivity with lithiation. More generally, current passing through the cell could be treated as a transmission line model, where the current in AAM electrode partially travelled through the solid AAM matrix and partially travelled across the liquid electrolyte, where the total would sum to the discharge current density during discharge processes. The relative electronic conductivity of the AAM solid and ionic conductivity of liquid electrolyte then determined the relative passage of the current through the AAM electrode. The use of a Li metal counter/reference electrode would minimize the resistance contribution (to R_{cell}) from the counter electrode side, and the voltage holds after constant current discharge were intended to homogenize the lithiation distribution across the thick AAM electrodes, where considerable lithiation gradients have been observed in some cases under constant current conditions in such AAM architectures. The large change in electronic conductivity of the solid AAM electrode would be expected to both change the relative distribution of current passed through the solid electrode and electrolyte, and furthermore result in changes to R_{cell}. It is noted that some irreversible reaction such as SEI formation (only first discharge was analyzed to mitigate this issue) and external cell connections will influence R_{cell} and made quantitative calculation of the AAM solid electronic conductivity difficult to reliably estimate; however, for the nominally identical cells with the 4 different processing conditions for the AAM TNO materials relative comparisons were examined.

R_{cell} for the initially prepared cells with the TNO AAM electrodes paired with Li metal all were around 6.8Ω. The electronic conductivity of the AAM electrodes without lithiation (based on the DC conductivity measurements of initially prepared electrodes) were over 8 orders of magnitude lower than the ionic conductivity of the carbonate-based electrolyte. Under such condition, the majority of the current through the AAM electrode region in the cell would have traversed via liquid electrolyte ionic pathways. For the 1000 C AAM electrode cell, the R_{cell} dropped to 4.24Ω at 1.6 V, increased until 1.4 V, stayed nearly unchanged at 1.2V, and finally decreased until 1.0 V. This outcome for R_{cell} qualitatively agreed with a sharp increase in electronic conductivity after initial lithiation (to a value above or at least comparable to the liquid electrolyte), followed by a decrease, and lastly an increase in electronic conductivity with further lithiation. This trend qualitatively matches the reported trend for electronic conductivity as a function of lithiation. The 800 C AAM electrode cell had a similar trend to the 1000 C, although the increase in R_{cell} was smaller below 1.6 V. For the 700 C AAM electrode cell, the initial decrease in R_{cell} was smaller compared to the 800 C and 1000 C, suggesting the initial electronic conductivity increase from lithiation was smaller. On further lithiation from reducing holding voltage down to 1.0 V, the R_{cell} monotonously increased without going back down, which was in contrast to the 800 C and 1000 C AAM electrode cells. For the 600 C AAM electrode cell, the trend was close to that of 700 C electrode cell, where the decrease in R_{cell} (attributed to the gain in electronic conductivity from the initial lithiation) was lower. In brief, the electronic conductivity gain from initial lithiation was the greatest for the 800 C and 1000 C, followed by the 700 C, and the 600 C, which was consistent with the trends observed in rate capability data (with the exception of 1000 C, with massive irreversible capacity loss with multiple cycles as an AAM electrode).

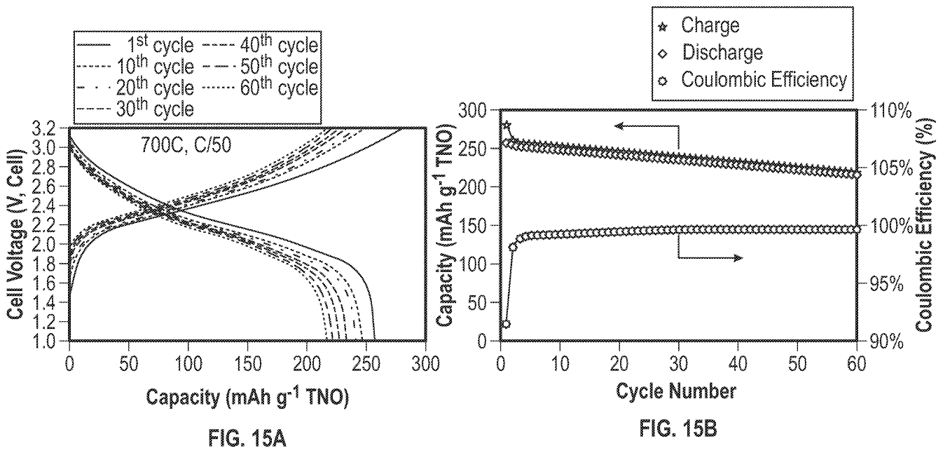

The 700 C sample was also cycled at a slightly larger voltage window between 1.0-3.2 V (all previous cells were cycled between 1.0-3.1 V) at C/50 to further probe its stability with larger extent of lithiation. FIG. 15 shows cycle life testing up to 60 cycles with selected voltage profiles. The first cycle charge and discharge capacity were 281 mAh g⁻¹ TNO and 257 mAh g⁻¹ TNO with an initial CE of ~91%. Examining the voltage profiles, the overpotential of the cell increased as the cell was cycled. The CE across the 60 cycles approached 100%, and the capacity retention at 60^{th} cycle was 84% (delivering 217 mAh g⁻¹ TNO). Under such high loading and thickness, this initial cycle life was promising.

### CONCLUSION

Titanium and niobium oxide materials were synthesized and processed using four different temperatures (1000° C., 800° C., 700° C., and 600° C.) where the target overall stoichiometry for Ti:Nb was 1:2 for all materials. These materials were subsequently fabricated into AAM electrodes, where the same processing temperature was used to form the AAM electrodes. The highest temperature processing resulted in high crystallinity phase pure TiNb₂O₇ material. The intermediate temperatures resulted in blend phases of titanium niobates and anatase, whereas the temperature was decreased further the structure was consistent with T-Nb₂O₅ phase (still with anatase and other titanium niobates). At the lowest temperature, the main phases observed were a blend of TT-Nb₂O₅ and anatase. The highest temperature processed sample, when fabricated into a AAM electrode, had the most severe capacity fade with cycling. This was interpreted to have likely resulted from mechanical degradation due to the large lattice volume change for the phase pure TiNb₂O₇ material. The intermediate temperature materials when processed into AAM electrodes had the highest stability and rate capability, where the stability was consistent with materials that had large fractions of the phase with the lowest volume change with lithiation and the higher rate capability was consistent with the materials that had the largest fraction of the phase with the highest electronic conductivity. This work suggests that in some cases blends of multicomponent phases can be beneficial and be used to tune the combination of desirable properties (e.g., rate capability, cycle life, energy density) in AAM electrode architectures. The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present subject matter. Thus, it should be understood that although the present subject matter has been specifically disclosed by specific aspects and optional features, modification and variation of the concepts herein disclosed may be resorted to by those of ordinary skill in the art, and that such modifications and variations are considered to be within the scope of aspects of the present subject matter.

### ADDITIONAL ASPECTS

The following exemplary aspects are provided, the numbering of which is not to be construed as designating levels of importance:

Aspect 1 provides an electrochemical storage device comprising materials with targeted stoichiometry of TiNb₂O₇ (TNO), MoO₂ (MO), or mixtures of TNO and MO.

Aspect 2 provides the electrochemical storage device of Aspect 1, wherein the electrode is a sintered electrode without binders or conductive additives explicitly added during electrode fabrication.

Aspect 3 provides the electrochemical storage device of any one of Aspects 1 or 2, wherein the electrode is a composite electrode.

Aspect 4 provides the electrochemical storage device of Aspect 3, wherein the composite electrode comprises a metallic substrate to which the TiNb₂O₇, MoO₂, LiCoO₂, LiNi_{0.5}Mn_{0.5}O₂, LiMn₂O₄, Li₄Ti₅O₁₂, a mixture of LiMn₂O₄ and LiCoO₂, multiple phases thereof, or mixture thereof is applied.

Aspect 5 provides the electrochemical storage device of Aspect 4, wherein the metallic substrate comprises a stainless steel, aluminum, alloys thereof, or mixtures thereof.

Aspect 6 provides the electrochemical storage device of any one of Aspects 1-5, wherein a thickness of the electrode is in a range of from about 50 μm to about 2000 μm.

Aspect 7 provides the electrochemical storage device of any one of Aspects 1-6, wherein a thickness of the electrode is in a range of from about 70 μm to about 400 μm.

Aspect 8 provides the electrochemical storage device of any one of Aspects 1-7, wherein the electrode is substantially free of a conductive additive.

Aspect 9 provides the electrochemical storage device of Aspect 8, wherein the conductive additive comprises a polymer binder, a conductive carbon, or a mixture thereof.

Aspect 10 provides the electrochemical storage device of any one of Aspects 1-9, wherein a porosity of the electrode is in a range of from about 30% to about 50%.

Aspect 11 provides the electrochemical storage device of any one of Aspects 1-10, wherein a porosity of the electrode is in a range of from about 35% to about 40%.

Aspect 12 provides the electrochemical storage device of any one of Aspects 1-11, wherein a capacity of the electrode is in a range of from about 7 mAh/cm² to about 100 mAh/cm².

Aspect 13 provides the electrochemical storage device of any one of Aspects 1-12, wherein a capacity of the electrode is in a range of from about 10 mAh/cm² to about 50 mAh/cm².

Aspect 14 provides the electrochemical storage device of any one of Aspects 1-13, wherein the electrode is an anode.

Aspect 15 provides the electrochemical storage device of any one of Aspects 1-14, wherein the electrode is a cathode.

Aspect 16 provides the electrochemical storage device of any one of Aspects 1-15, wherein the electrode comprises one dopant.

Aspect 17 provides the electrochemical storage device of Aspect 16, wherein the electrode comprises at least two dopants.

Aspect 18 provides the electrochemical storage device of any one of Aspects 16 or 17, wherein the at least one dopant has a 1⁺, 2⁺, or 3⁺ oxidation state.

Aspect 19 provides the electrochemical storage device of any one of Aspects 1-18, wherein the at least one dopant comprises copper, aluminum, sulfur, potassium, or a mixture thereof.

Aspect 20 provides the electrochemical storage device of any one of Aspects 1-19, wherein the electrode is a battery anode.

Aspect 21 provides the electrochemical storage device of any one of Aspects 1-20, wherein the electrode is a battery cathode.

Aspect 22 provides the electrochemical storage device of any one of Aspects 1-22, wherein the electrode is free of a binder, an inactive solid additive, or a mixture thereof.

Aspect 23 provides the electrochemical storage device of any one of Aspects 1-22, further comprising a carbon coating at least partially disposed over the electrode.

Aspect 24 provides the electrochemical storage device of Aspect 23, wherein the carbon coating is disposed over about 30% to about 100% of a total surface area of the electrode.

Aspect 25 provides the electrochemical storage device of Aspect 24, wherein the carbon coating is disposed over about 60% to about 95% of a total surface area of the electrode.

Aspect 26 provides a lithium-ion battery comprising:
a first electrode corresponding to the electrode of any one of Aspects 1-25;
a second electrode spaced apart from the first electrode;
an electrolyte in contact with the first electrode and the second electrode; and
a separator positioned between the first electrode and the second electrode.

Aspect 27 provides the lithium-ion battery of Aspect 26, wherein the electrolyte comprises a salt.

Aspect 28 provides the lithium-ion battery of any one of Aspects 26 or 27, wherein the separator comprises a porous polymer or glass fiber impregnated with electrolyte.

Aspect 29 provides the lithium-ion battery of Aspect 28, wherein the polymer comprises a polyurethane, a polypropylene, a polyethylene, a copolymer thereof, or a mixture thereof.

Aspect 30 provides the electrochemical storage device of any one of Aspects 1-29, wherein the electrochemical storage device comprises a lithium-ion battery.

Aspect 31 provides an article comprising the electrochemical storage device of any one of Aspects 1-30.

Aspect 32 provides the article of Aspect 31, wherein the article comprises a vehicle or an electronic device.

Aspect 33 provides a method of making the electrode of any one of Aspects 1-32, the method comprising:
contacting components of an electroactive material;
blending the components of the electroactive material; and
sintering the blended electroactive material to form the sintered electrode.

Aspect 34 provides the method of Aspect 33, wherein the sintering is performed at a temperature in range of from about 500° C. to about 1100° C.

Aspect 35 provides the method of any one of Aspects 33 or 34, wherein the sintering is performed at a temperature in range of from about 700° C. to about 900° C.

Aspect 36 provides the method of any one of Aspects 33-35, wherein sintering is performed at a variable temperature.

Aspect 37 provides the method of any one of Aspects 33-36, wherein sintering is performed over a period of time in a range of from about 0.1 hours to about 20 hours.

Aspect 38 provides the method of any one of Aspects 33-37, wherein sintering is performed over a period of time in a range of from about 16 hours to about 18 hours.

1. An electrochemical storage device comprising an electrode having materials with targeted stoichiometry of TiNb₂O₇ (TNO), MoO₂ (MO), or mixtures of TNO and MO.

2. The electrochemical storage device of claim 1, wherein the electrode is a sintered electrode without binders or conductive additives explicitly added during electrode fabrication.

3. The electrochemical storage device of claim 1, wherein the electrode is a composite electrode.

4. The electrochemical storage device of claim 3, wherein the composite electrode comprises a metallic substrate to which the TiNb₂O₇, MoO₂, LiCoO₂, LiNi_{0.5}Mn_{0.5}O₂, LiMn₂O₄, Li₄Ti₅O₁₂, a mixture of LiMn₂O₄ and LiCoO₂, multiple phases thereof, or mixture thereof is applied.

5. The electrochemical storage device of claim 4, wherein the metallic substrate comprises a stainless steel, aluminum, alloys thereof, or mixtures thereof.

6. (canceled)

7. (canceled)

8. (canceled)

9. The electrochemical storage device of claim 1, wherein the electrode is substantially free of a conductive additive comprising a polymer binder, a conductive carbon, or a mixture thereof.

10. (canceled)

11. (canceled)

12. (canceled)

13. (canceled)

14. (canceled)

15. (canceled)

16. (canceled)

17. (canceled)

18. The electrochemical storage device of claim 1, wherein the electrode further comprises at least one dopant or two dopants having a 1⁺, 2⁺, or 3⁺ oxidation state.

19. The electrochemical storage device of claim 18, wherein the at least one dopant or two dopants comprises copper, aluminum, sulfur, potassium, or a mixture thereof.

20. (canceled)

21. (canceled)

22. The electrochemical storage device of claim 1, wherein the electrode is free of a binder, an inactive solid additive, or a mixture thereof.

23. The electrochemical storage device of claim 1, further comprising a carbon coating at least partially disposed over the electrode.

24. (canceled)

25. (canceled)

26. A lithium-ion battery comprising:
a first electrode corresponding to the electrode of claim 1;
a second electrode spaced apart from the first electrode;
an electrolyte in contact with the first electrode and the second electrode; and
a separator positioned between the first electrode and the second electrode.

27. The lithium-ion battery of claim 26, wherein the electrolyte comprises a salt.

28. The lithium-ion battery of claim 26, wherein the separator comprises a porous polymer or glass fiber impregnated with electrolyte.

29. The lithium-ion battery of claim 28, wherein the polymer comprises a polyurethane, a polypropylene, a polyethylene, a copolymer thereof, or a mixture thereof.

30. The electrochemical storage device of claim 1, wherein the electrochemical storage device comprises a lithium-ion battery.

31. An article comprising the electrochemical storage device of claim 1.

32. The article of claim 31, wherein the article comprises a vehicle or an electronic device.

33. A method of making the electrode of claim 1, the method comprising:
contacting components of an electroactive material;
blending the components of the electroactive material; and
sintering the blended electroactive material to form the sintered electrode.

34. The method of claim 33, wherein the sintering is performed at a temperature in range of from about 500° C. to about 1100° C.

35. (canceled)

36. The method of claim 33, wherein sintering is performed at a variable temperature.

37. (canceled)

38. (canceled)
